(19) United States
(12) Patent Application Publication
(10) Pub. No.: US 2026/0050651 A1
(43) Pub. Date: Feb. 19, 2026

(54) QUANTUM ANNEALING-BASED HYBRID STRATEGIES FOR REAL-TIME ROUTE OPTIMIZATION

(71) Applicant: Unisys Corporation, Blue Bell, PA (US)

(72) Inventors: Salvatore SINNO, Co. Durham (GB); Anees AHMED, Bengaluru (IN); Shruthi THURAVAKKATH, Bangalore (IN)

(21) Appl. No.: 19/189,104

(22) Filed: Apr. 24, 2025

Related U.S. Application Data
(60) Provisional application No. 63/683,147, filed on Aug. 14, 2024.

(51) Int. Cl. G06F 17/18

(52) U.S. Cl. CPC G06F 17/18

(57) ABSTRACT

Methods, systems, and computer storage media for solving optimization problems are disclosed. Problem parameters of an optimization problem are received where the optimization problem has a solution space larger than a solution space threshold. Clustering is performed to reduce the solution space below a solution space threshold, and routing is performed to determine the routing options using the clusters. Solutions are received using simulated annealing on the clusters with the reduced solution space, the one or more solutions are recombined to generate a solution, and the solution is provided via a user interface.

### CROSS-REFERENCE TO RELATED APPLICATIONS

This non-provisional patent application claims priority to U.S. Provisional Patent Application No. 63/683,147, filed on Aug. 14, 2024, and titled “QUANTUM ANNEALING BASED HYBRID STRATEGIES FOR REAL TIME ROUTE OPTIMIZATION,” the entire contents of which is incorporated by reference herein.

### BACKGROUND

Capacitated Vehicle Routing Problem (CVRP) is a problem in transportation and logistics, involving optimizing a set of truck routes to service a set of customers that are subject to limits on truck capacity and that seek to reduce travel costs. There are many challenges in solving this problem. One challenge is that the time complexity of the issue grows exponentially with the number of customers and trucks, rendering the solution intractable when using traditional computers and algorithms.

### SUMMARY

The technology generally relates to systems for more efficiently solving routing problems using a method to solve the time complexity problem for CVRP, employing quantum computers to aid classical computers in solving problems faster while reducing complexity. The systems for more efficiently solving routing problems using a method to solve the time complexity problem for CVRP and employing quantum computers use two algorithms. These are a Hybrid Two-Step (H2S) algorithm and a Hybrid Three-Step (H3S). Both algorithms include a clustering phase and a routing phase, described herein. As may be contemplated, other algorithms used by systems for more efficiently solving routing problems using a method to solve the time complexity problem for CVRP and employing quantum computers can be used.

Transportation and logistics algorithms enable the efficient transfer of goods and services from the centers of production to those of consumption. To efficiently use resources, the logistics and transportation systems must be efficient in terms of both cost and time to ensure the seamless operation of businesses and industries and the satisfaction of customers. Inefficient routing can require a considerable amount of computing resources, requiring the use of those resources to heuristically determine a solution that may not be optimal. As transportation and logistics algorithms must account for many factors including, but not limited to, rising fuel costs, environmental issues, traffic congestion, and/or suboptimal routing and scheduling of trucks, less-than-optimal routing and scheduling can result in increased operational costs, extended delivery times, increased use of computing resources, and, consequentially, lower profit margins. An efficient and robust vehicle routing algorithm can reduce operational costs, reduce delivery times, reduce the use of computing resources, and increase profit margins.

Several optimization techniques have been previously employed to handle real-time route optimization issues. Typically, these techniques are restricted by the magnitude of the problem and complexity of the problem. Typically these techniques do not provide optimal solutions within a reasonable timeframe. One well-known theoretical problem in this domain is that of the travelling salesman problem (TSP). The TSP posits that, given a collection of cities and the distance of travel between each pair, what is the shortest route to traverse, such that each city is visited exactly once before returning to the starting point. Obtaining optimal delivery routes by solving the TSP can enhance resource usage, including the use of delivery trucks, reducing empty miles and increasing operational efficiency. However, conventional techniques cannot deterministically solve the TSP in polynomial time (for example, within a determinable period of time) because the TSP is nondeterministic polynomial time-hard (NP-hard) and, thus, provably cannot be deterministically solved in polynomial time.

The capacitated vehicle routing problem (CVRP), a variant of the TSP, is a combinatorial optimization problem that is similarly relevant to the logistics and transportation industry. The problem states that given a collection of n customers, each with a known demand and location, and a fleet of m trucks, each with a given capacity, the objective is to identify a set of truck routes that serves all customers while minimizing total distance traveled. Like the traveling salesman problem, the CVRP is also NP-hard. Quantum Annealing (QA) is an optimization technique that can be used to solve the CVRP.

Quantum annealing is an adaptation of simulated annealing, which is a meta-heuristic that employs temperature fluctuations to guide a solution down an energy landscape. QA exploits principles of quantum mechanics in addition to the natural tendency of any system to exist in the least possible energy state, allowing for a more efficient traversal of the landscape. QA has shown promise in solving route optimization issues more effectively than its counterparts in classical computing. The technology described herein generally relates to systems for more efficiently solving optimization problems using QPUs (quantum processing units).

This summary is intended to introduce a selection of concepts in a simplified form that is further described in the Detailed Description section of this disclosure. The Summary is not intended to identify key or essential features of the claimed subject matter, nor is it intended to be an aid in determining the scope of the claimed subject matter. Additional objects, advantages, and novel features of the technology will be set forth in part in the description that follows, and in part will become apparent to those skilled in the art upon examination of the disclosure or learned through practice of the technology.

### BRIEF DESCRIPTION OF THE DRAWINGS

The present technology is described in detail below with reference to the attached drawing figures, wherein:

FIG. 1 illustrates an example operating environment in which aspects of the technology may be employed, in accordance with an aspect described herein;

FIG. 2 is a block diagram illustrating an example route optimization system used to solve a routing problem, in accordance with an aspect described herein;

FIG. 3 is a block diagram illustrating an example route optimization clustering module to solve a routing problem, in accordance with an aspect described herein;

FIG. 4 is a block diagram illustrating an example quantum routing solver, in accordance with an aspect described herein;

FIG. 5 is a block diagram illustrating an example quantum annealer, in accordance with an aspect described herein;

FIG. 6 is a block diagram illustrating an example quantum annealing process, in accordance with an aspect described herein;

FIG. 7 is a flow diagram illustrating an example process for generating a solution to a route optimization problem, in accordance with an aspect described herein;

FIG. 8 is a flow diagram illustrating an example process for performing clustering in association with generating a solution to a route optimization problem, in accordance with an aspect described herein;

FIG. 9 is a block diagram illustrating example routes using a hybrid three-step (HS3) algorithm, in accordance with an aspect described herein;

FIG. 10 is a block diagram illustrating example routes using a hybrid two-step (HS2) algorithm, in accordance with an aspect described herein; and

FIG. 11 is a block diagram illustrating an example computing device that may implement aspects of the described technology, in accordance with an aspect described herein.

### DETAILED DESCRIPTION

Optimization problems involve finding the best solution from a set of possible solutions that are bounded by various constraints and measured by an objective function, as defined by decision variables. Optimization aims to find an optimal and feasible set of values for the decision variables, one that minimizes or maximizes the value of the objective function while simultaneously satisfying all constraints. The problem can be constructed in various ways, depending on how the objective and constraints are represented. Quadratic Unconstrained Binary Optimization (QUBO) is one representation identified to be compatible with QA.

The problem can first be represented in standard mathematical notation, with the decision variables, objective, and constraints defined. Conversion to a QUBO format then involves first replacing discrete and continuous-valued variables with binary equivalents. The CVRP lends itself naturally to the task, as the primary decision is whether to allocate a truck to a customer (1) or not (0). Then, unconstraining is performed, where inequality constraints are transformed into equations using Lagrange parameters. Finally, quadratization is performed, which reduces polynomial expressions to equivalent quadratics by introducing new binary variables and mappings that relate them to the previous variables.

The solution space of an optimization problem can be represented as an energy landscape in n-dimensional space. Each particle (point) in the landscape represents a single solution. Peaks are associated with high energy values, while valleys are associated with low energy values. The Hamiltonian is a mathematical operator used in physics to represent the total energy contained within a physical system. It is used to seek and settle in a stable state with the lowest possible energy. Thus, a lower value of the Hamiltonian indicates a more optimal solution than a higher value. Therefore, the objective function of an optimization problem can be represented in the form of a Hamiltonian, and the problem becomes one of minimization. When the solution space of an optimization problem is larger than a solution space threshold for a proposed solution methodology, the proposed solution methodology may not be used, or may not be computationally tractable, or may not be able to be performed using existing or available computing resources.

QA is a technique that employs quantum mechanical principles to aid in locating the global minimum of an objective function. This is achieved by using small fluctuations in magnetic fields to guide particles through the energy landscape. Variations in the field produce different values of the variables and, thus, different solutions. A property of quantum particles that enables them to perform the traversal of the landscape more efficiently is quantum tunneling, which allows them to tunnel through an energy barrier, represented by a peak, instead of ascending and then descending that peak. Additionally, the particles can exist in a combination of different states simultaneously, thus permitting consideration of several parallel solutions instead of in sequence.

Clustering can be used to generate solutions for optimization problems that have a solution space that is smaller than a solution space threshold. As described below, one measure of the complexity of an optimization is the constraint density, which is the ratio between the number of variables and the number of constraints. A higher constraint density can result in a larger solution space threshold. QA techniques can have a solution space threshold that is determined by the quantum hardware. The quantum architecture of a quantum device can be limited by, for example, a maximum density ratio, as defined in Equation (1), below. When the solution space of an optimization problem exceeds this threshold, the quantum device may be unable to generate a solution or may only generate a locally optimal solution. Techniques described herein improve the functioning of the quantum device by reducing the solution space of the optimization problem using clustering. By performing clustering, the solution space of the optimization problem is reduced so that it is smaller than the solution space threshold of the quantum device.

One aim of QA is to identify the lowest value of the objective, represented by a Hamiltonian in QUBO formulation. It accomplishes this by employing quantum processing units (QPUs) to generate a quantum state representing all potential solutions to the QUBO problem. This quantum state is then “annealed” until it settles into the lowest energy state, representing a solution to the problem. The quantum system is started in a simple, known state and then allowed to evolve according to a Hamiltonian that encapsulates the objective of the optimization problem. The Hamiltonian is gradually altered over time by annealing until the system achieves the ground state, which represents the ideal solution to the optimization issue. One of the primary advantages of quantum annealing over classical techniques is the possibility for exponential speedup for specific optimization problems, such as those that can be translated onto the Ising model, a variant of QUBO that utilizes spin variables. However, fruitful application of QA must overcome various hurdles, including the requirement for high-quality qubits shielded from external noise and the capacity to sustain quantum coherence for an extended period, the absence of which leads to a devolution of the quantum state.

A feasible solution to an optimization problem satisfies all the constraints associated with the optimization problem. In order to accommodate these constraints in the energy landscape, constraints can be transformed into penalties and included as part of the objective function. A penalty introduces a large positive value if its condition is met, thereby increasing the Hamiltonian and rendering the solution less optimal. Constraints can be either in the form of an equation or an inequality. When the solution space of the optimization problem is lower than the solution space threshold of the quantum hardware (for example, that of the QPUs), a feasible solution to the optimization problem can be generated. When the solution space of the optimization problem is greater than the solution space threshold for the quantum hardware, the quantum hardware may fail to generate a solution, or may generate a solution that does not satisfy all the constraints associated with the optimization problem. By reducing the solution space of the optimization problem using clustering, the solution space of the optimization problem is reduced so that it is smaller than the solution space threshold of the quantum device, thereby improving the functionality of the quantum device, enabling it to produce better solutions and allowing it to solve larger and more complex problems.

Lagrange parameters are tunable values traditionally introduced in operations research when solving optimization problems when converting inequalities in constraints to equations using slack and surplus variables. When introducing constraints as penalties to the objective function, Lagrange parameters serve as weights to prioritize the satisfaction of a constraint. High values will tend to orient the solution towards strict feasibility at the expense of optimality in terms of high solution cost and vice versa.

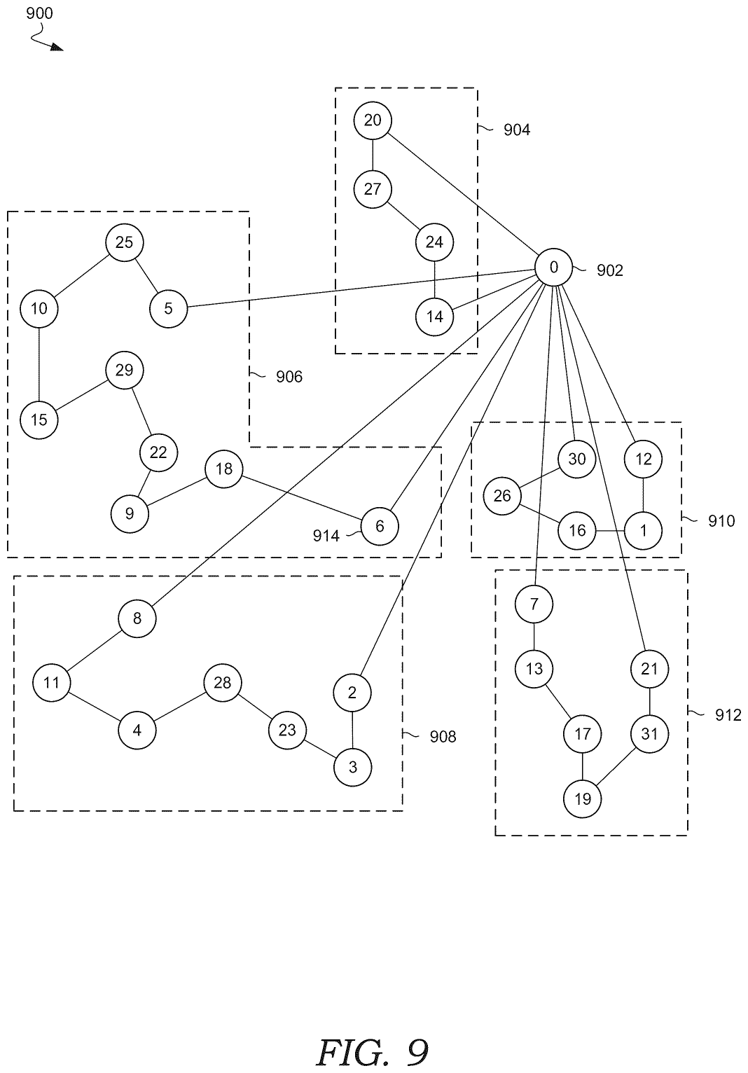

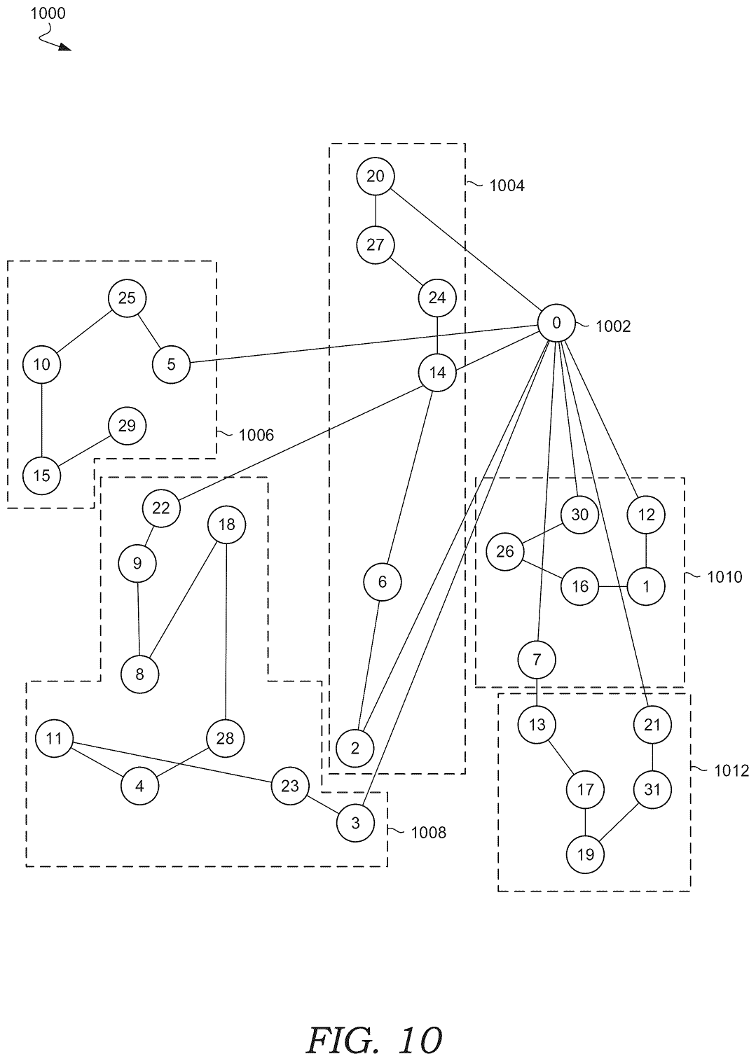

For a solution to the CVRP to be optimal, it must consider the spatial arrangement of customers, or risk increased transportation costs due to inefficient routes. Solving an unaltered CVRP using current quantum annealers can be a time-consuming and energy-inefficient process and can, in some instances, exceed the capabilities of the quantum hardware. Scalability to larger instances is another issue, stemming from QPUs being limited in their number of qubits to maintain coherence. This can be partially alleviated by tasking additional qubits to counteract noise, but this confers an overhead in time and cost. However, these shortcomings can be addressed by employing a hybrid approach of both classical and quantum solvers, working in tandem with their strengths, as described herein. It should be noted that a CVRP can have a very large solution space, typically on the order of n-factorial (n!) where “n” is the number of nodes. In the example illustrated in FIGS. 9 and 10, with thirty-two nodes, there may be in excess of 2×10³⁵ solutions. By performing clustering, this solution space can be reduced considerably, as described herein.

As described herein, a hybrid approach involves dividing the CVRP into two sub-problems, namely capacitated clustering and routing. Clustering is typically performed using a classical algorithm such as K-Means clustering, adapted to include capacity and demand satisfaction of the vehicles and customers. Clustering groups individual customers into m clusters, where the number of clusters is typically equal to the number of trucks, and the clusters are determined based on proximity and capacity considerations. Due to its computationally intensive nature that involves repeated mathematical calculations, clustering lends itself well to computation on a classical computer. On the other hand, routing between customers in a cluster benefits greatly from evaluating multiple potential solutions in parallel, an apt use case for a quantum computer. However, as described above, quantum hardware is limited by a solution space threshold. The size of the solution space is reduced by clustering, enabling the QA algorithm to find an optimal solution in an efficient manner. By using clustering to reduce the solution space, the functioning of the quantum hardware is improved, enabling it to generate better solutions. Clustering also uses the quantum hardware more efficiently by enabling it to better converge to a solution for the cluster, avoiding computationally costly backtracking. Clustering also allows the use of quantum hardware on larger and more complex problems, thereby expanding the list of uses for quantum hardware and QA. As described herein, this hybrid approach using clustering addresses the limitations of both classical and quantum computers, using each to improve the performance of the other. Classical computers can perform the clustering efficiently, but not the annealing. Quantum computers can perform the annealing efficiently when clustering is first performed to reduce the solution space below the solution threshold. When the CVRP is decomposed into m problem instances by clustering, the CVRP can be solved by solving, for example, m instances of the TSP, with each truck assigned to a cluster serving as its “salesman”, and then recombining these solutions to generate an optimal solution to the CVRP. As described herein, hybrid approaches (for example, hybrid two-step and hybrid three-step approaches) that employ the Fuzzy C-means (FCM) algorithm for clustering and QA for routing can be used to solve a routing problem, as described herein.

The technology described herein uses clustering to enable quantum hardware to solve larger and more complex problems, to generate more accurate solutions, and to more efficiently use computational resources to solve such problems. The technology described herein thus enables the generation of solutions to a larger set of vehicle routing problems. The technology described herein also executes more efficiently on the quantum hardware, as decomposing the problem into sub-problems using clustering reduces the constraint density and the solution space of each of the problem instances. This more efficiently uses computational resources to solve vehicle routing problems, improving both the efficiency and speed of computing systems used to generate solutions to vehicle routing problems while reducing latency in generating those solutions by, for example, reducing costly backtracking and problem resubmission. This improves the time to generate a solution to a vehicle routing problem, thereby improving transportation logistics and reducing overall costs.

It will be realized that the methods described herein are only examples that can be practiced from the description that follows, and they are provided to more easily understand the technology and recognize its benefits. Additional examples are now described with reference to the figures.

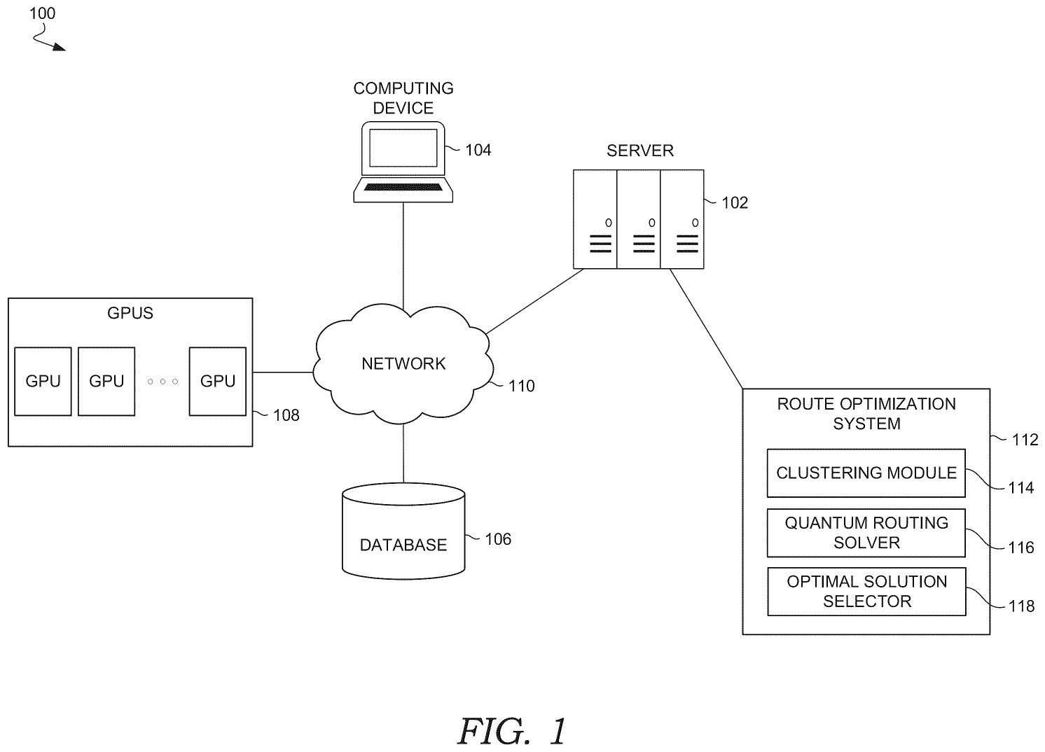

With reference now to FIG. 1, an example operating environment 100 in which aspects of the technology may be employed is provided. Among other components or engines not shown, operating environment 100 comprises a server 102, a computing device 104, a database 106, and GPUs 108, all of which can communicate via network 110. As illustrated in FIG. 1, server 102 performs a route optimization system 112, described below.

Database 106 can store information, including data, computer instructions (for example, software program instructions, routines, or services), or models used in embodiments of the described technologies. Although depicted as a single database component, database 106 may be embodied as one or more databases or may be in the cloud. Database 106 can be representative of a distributed ledger network (for example, a system where data is replicated, shared, and synchronized over a plurality of locations that may be geographically distinct).

The components illustrated in block diagram 100 can communicate via the network 110. In an aspect, the network 110 includes one or more networks (for example, public network or virtual private network or “VPN”). The network 110 can include, without limitation, one or more local area networks (LANs), wide area networks (WANs), or any other communication network or method. Such networking environments are commonplace in offices, enterprise-wide computer networks, intranets, and the internet. It should be understood that any number of user devices and servers (for example, computing device 104, server 102, and/or GPUs 108) can be employed within the system illustrated in block diagram 100 within the scope of the present technology. Each device or server may comprise a single device or multiple devices cooperating in a distributed environment. For example, the route optimization system 112 can be provided by multiple server devices (for example, a plurality of server 102 components) collectively providing the functionality of the route optimization system 112, as described herein. Additionally, other components not shown may also be included within the system illustrated in FIG. 1.

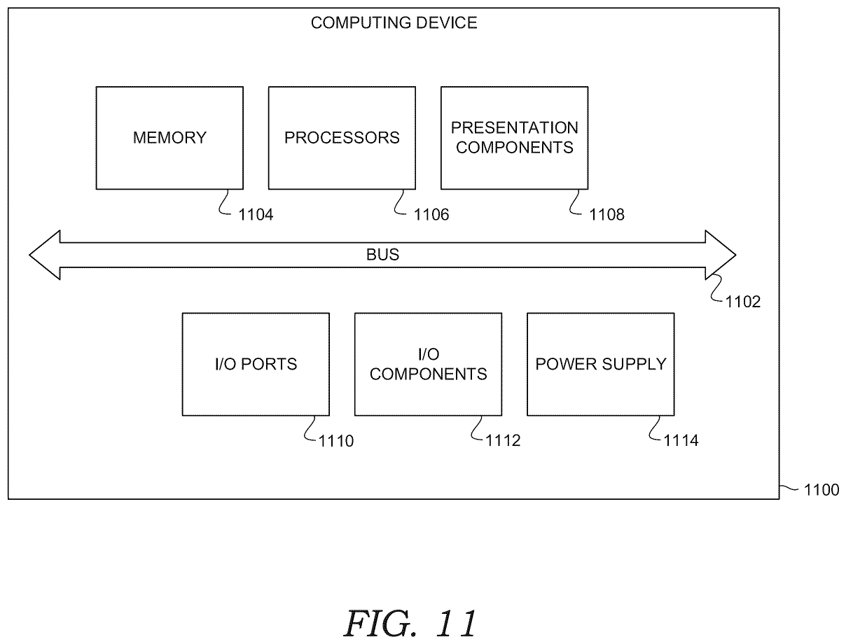

Generally, server 102 is a computing device that implements functional aspects of the operating environment described in FIG. 1, such as one or more functions of route optimization system 112 to optimally determine a solution to a vehicle routing problem (VRP) or a capacitated vehicle routing problem (CVRP). One suitable example of a computing device that can be employed as server 102 is described as computing device 1100 with respect to FIG. 11. In implementations, server 102 represents a back-end or server-side device. In an aspect, the example operating environment 100 can comprise server-side software (for example, executing on server 102) that is designed to work in conjunction with client-side software (for example, on computing device 104) so as to implement any combination of the features and functionalities discussed in the present disclosure. For example, the computing device 104 can include an application (not shown in FIG. 1) for interacting with the server 102 (including the route optimization system 112), the GPUs 108, and/or the database 106. This application can be, for instance, a web browser or a dedicated application for providing functions, such as those described herein. This division of the operating environment illustrated in block diagram 100 is provided to illustrate one example of a suitable environment. There is no requirement for each implementation that any combination of the computing device 104 and the rest of the entities of block diagram 100 remain as separate entities. For example, while the operating environment illustrated in block diagram 100 illustrates a configuration in a networked environment with a separate computing device 104, it should be understood that other configurations can be employed in which aspects of the various components are combined. For example, aspects of the various entities described herein can be implemented in part or in whole by the computing device 104, in whole or in part by the server 102, in whole or in part by the GPUs 108, and/or in whole or in part by components such as those, not illustrated in FIG. 1.

Computing device 104 is generally a computing device that may be used to interface with server 102. The computing device 104 may comprise any type of computing device capable of use by a user. For example, computing device 104 can be a computing device such as the computing device 1100 described in relation to FIG. 11. By way of example and not limitation, the computing device 104 can be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. A user, not shown in FIG. 1, can be associated with the computing device 104 and can interact with the other entities of the example operating environment described in FIG. 1.

In general, computing device 104 can receive inputs, such as a routing problem, as described herein. Computing device 104 can also receive a solution to that routing problem from the route optimization system 112 which comprises an optimal routing for vehicles. This solution can be displayed using computing device 104.

As with other components of FIG. 1, computing device 104 is intended to represent one or more computing devices. As described above, one suitable example of a computing device that can be employed as computing device 104 is described as computing device 1100 with respect to FIG. 11. In implementations, computing device 104 is a client-side or front-end device. While the example architecture illustrated in FIG. 1 illustrates functions of the route optimization system 112 being performed by server 102, it will be understood that this is just one example, and there may be more or fewer functions of the route optimization system 112, which may be employed in various orders. It is further noted that, in some implementations of the technology, functions of the route optimization system 112 can be performed by other components of FIG. 1, or by components not shown in FIG. 1. As an example, in some implementations, computing device 104 may be used to perform functions of the route optimization system 112 in lieu of or in combination with server 102. The example illustrated in FIG. 1 is but one example used to aid in describing an aspect of the technology.

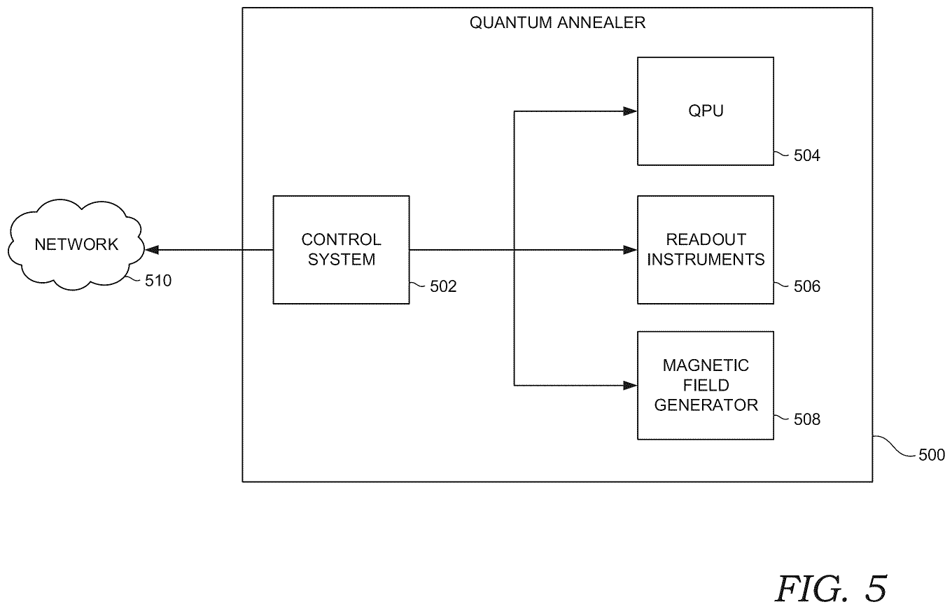

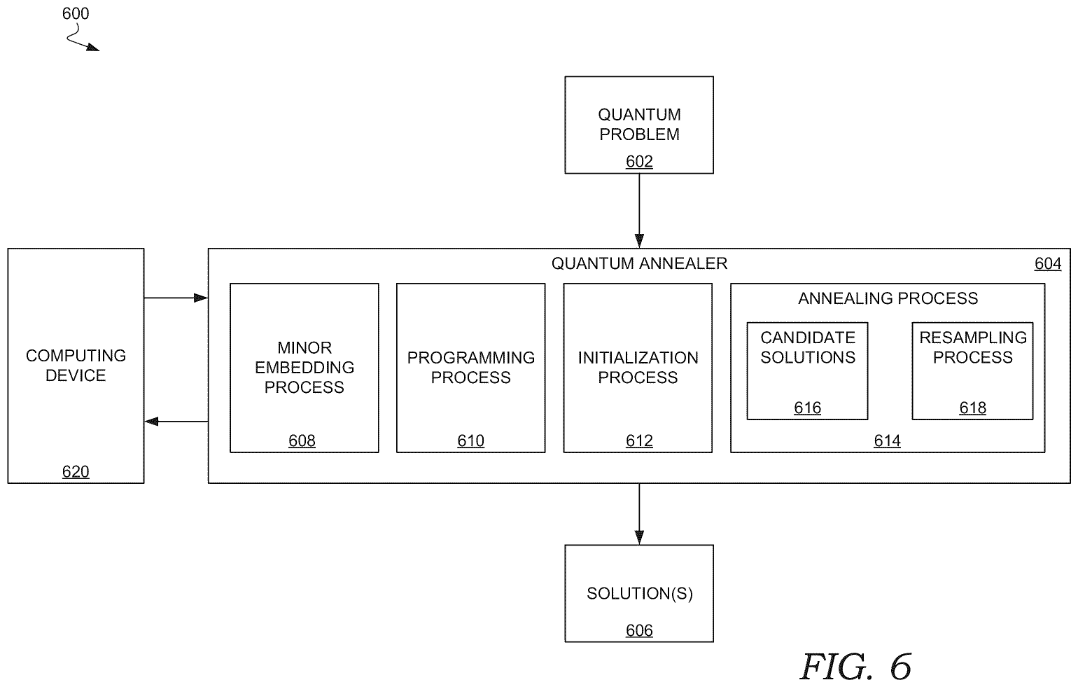

In an aspect, not shown in FIG. 1, the example operating environment 100 can include a quantum annealer that comprises a quantum computing device, such as those suitable for performing quantum annealing, such as the quantum annealer 500, described in connection with FIG. 5. As used herein, a quantum annealer is an analog quantum computing device that can receive instructions from other components of FIG. 1 for solving a quantum problem, such as a route optimization problem, as described herein. A quantum annealer can be configured to determine or receive a quantum problem and find an optimal or near-optimal solution to the problem through an annealing process, such as the quantum annealing process illustrated in block diagram 600, described herein in connection with FIG. 6.

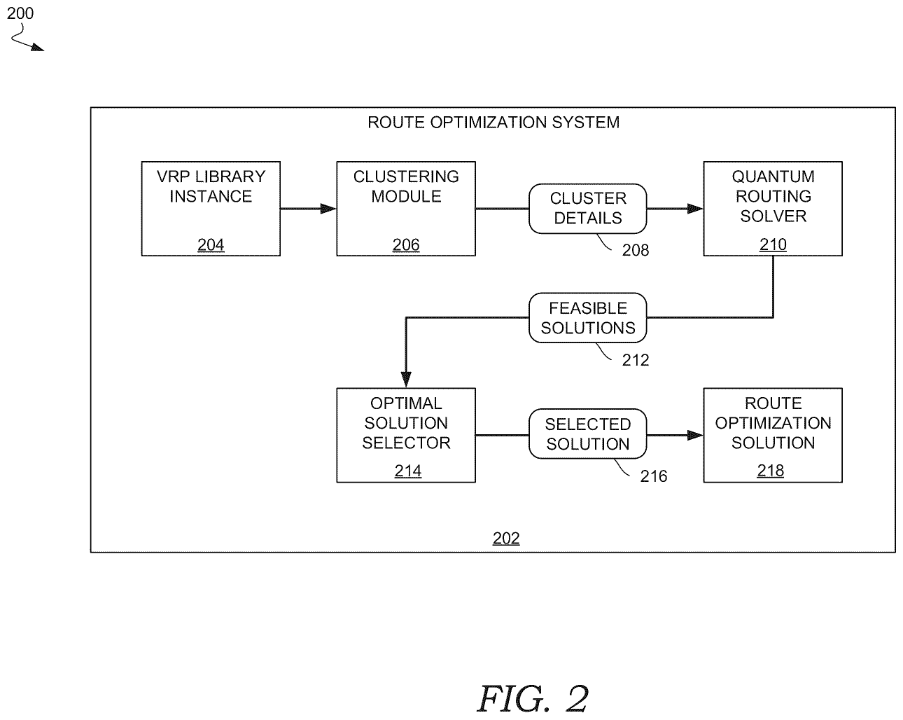

The route optimization system 112 can determine an optimal routing of vehicles to various locations. The route optimization system 112 determines an optimal route by invoking a quantum annealer 500 to solve optimization problems and generate an optimal routing of vehicles to different locations. In an aspect, route optimization system 112 comprises a clustering module 114, a quantum routing solver 116, and/or an optimal solution selector 118, all described in detail below at least in connection with FIGS. 2-4.

As used herein, a vehicle encompasses any mobile system capable of transporting goods, materials, or individuals across various terrains or environments, such as land, air, or sea. Vehicles include, but are not limited to, cars, trucks, airplanes, ships, drones, and autonomous vehicles, all of which facilitate the movement and delivery of cargo from one location to another. A payload area of a vehicle is a location that accepts a payload, such as cargo blocks, for transport by the vehicle. Vehicles may have one or more designated payload areas. As described herein, vehicles have specialized weight requirements, such as weight distribution or location requirements. For instance, sea vessels may require weight to be placed lower so that the center of gravity remains low, aircraft may require that weight be distributed to maintain a specific center of gravity, while tractor trailers may require weight to be placed between axles, or other like weight requirement.

Database 106 can include vehicle data as well as customer data such as locations and requirements. Vehicle data generally comprises data related to a vehicle. Vehicle data can include the type of vehicle, the maximum carrying capacity of the vehicle, weight distribution requirements, a location of a center of mass of the vehicle, a volume of a payload area of the vehicle, length of the payload area, vehicle cargo restrictions (such as restrictions on the type of cargo that can be carried by the vehicle), the vehicle location, and/or other vehicle data for determining a solution to a vehicle routing problem.

As described above, data such as vehicle data and/or customer data can be provided by and stored in database 106. This data can be provided by computing device 104 or by other components of the example operating environment illustrated in FIG. 1. In an aspect, data in the database 106 is provided by external entities, not shown in FIG. 1. For example, a manufacturer of a vehicle can provide such data. Similarly, a customer can provide customer data usable to determine a solution to a vehicle routing problem. Data in database 106 can be directly provided by such external entities using the network 110. Data in the database 106 can be provided by a user of the computing device 104 (for example, the data can be manually entered from information received such as, for example, a bill of lading). In an aspect, various constraints on a vehicle routing problem such as those described herein may be stored in the database 106. As described below, route optimization system 112 can access database 106 to retrieve data for use by its components in determining a solution to a vehicle routing problem. In an embodiment, not shown in FIG. 1, the route optimization system 112 can access database 106 directly via the network 110.

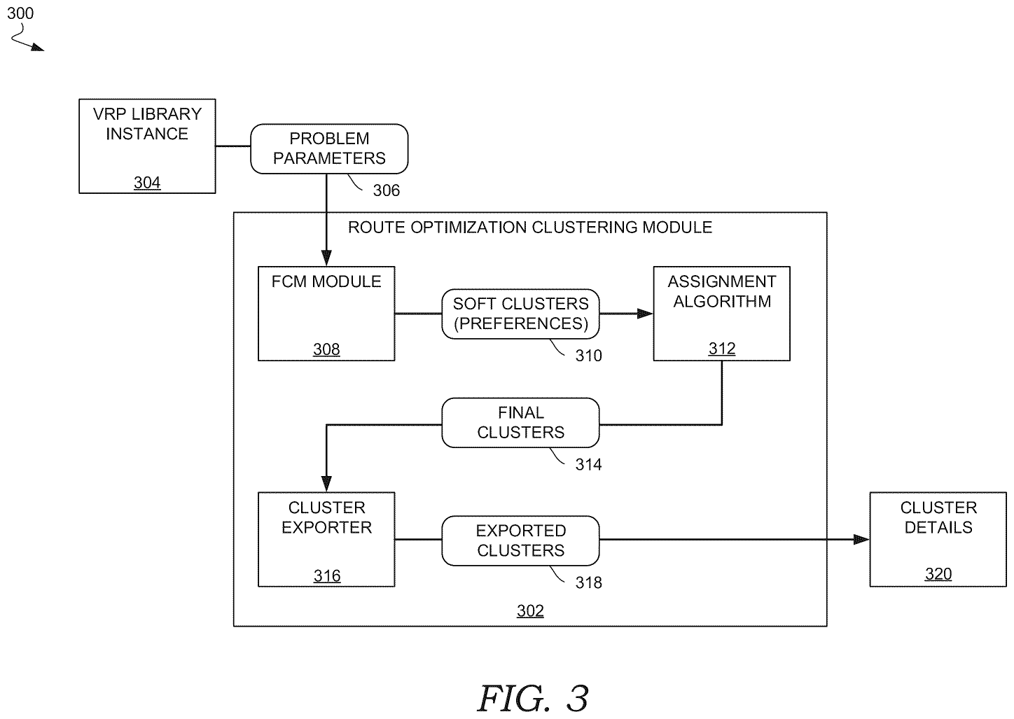

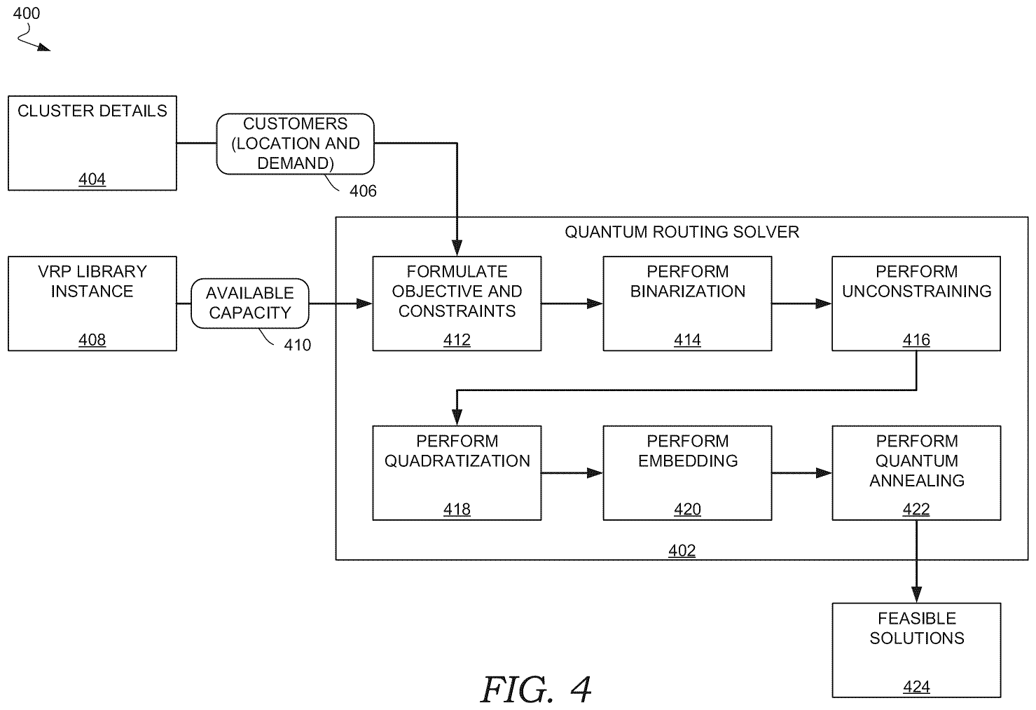

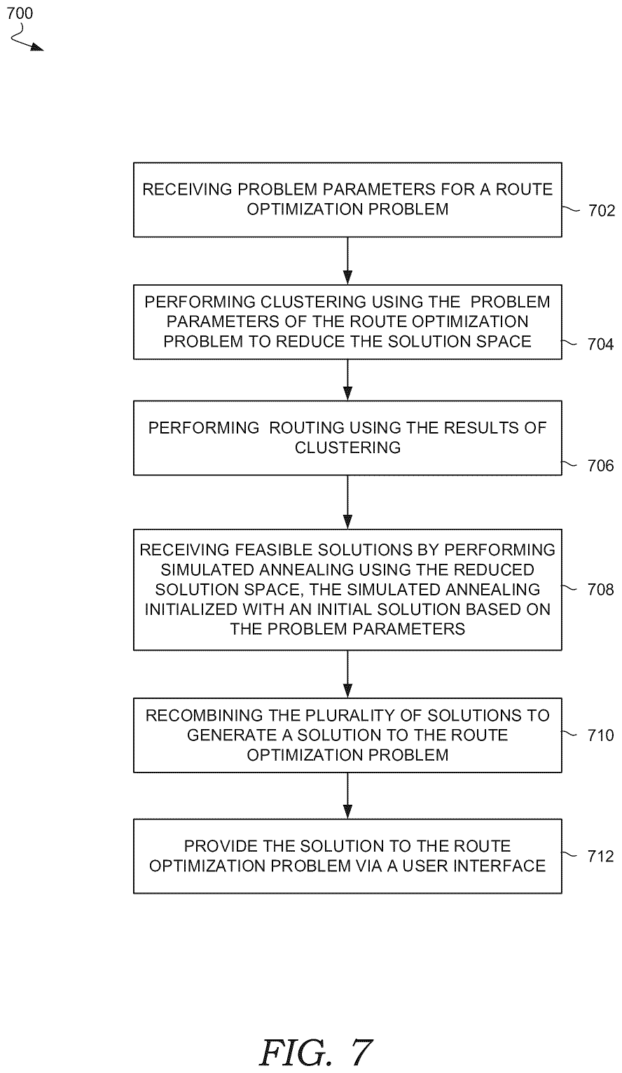

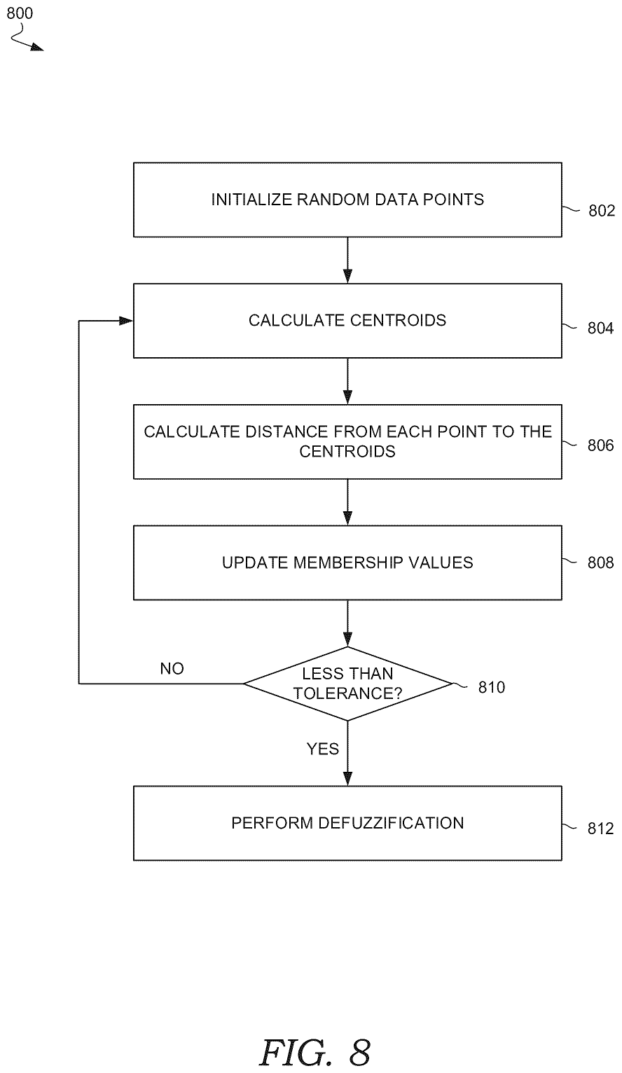

The route optimization system 112 can use the clustering module 114, the quantum routing solver 116, and/or the optimal solution selector 118 to determine an optimal solution to a vehicle routing problem using a quantum annealer 500, as described at least in connection with FIGS. 2-6. Flow diagram 700 and flow diagram 800, described in connection with FIGS. 7 and 8 respectively, provide additional details of processes and methods for the route optimization system 112 to use the clustering module 114, the quantum routing solver 116, and/or the optimal solution selector 118 to determine an optimal solution to a vehicle routing problem. The route optimization system 112 is described in detail in connection with FIG. 2. The clustering module 114 is described in detail in connection with FIGS. 2 and 3. The quantum routing solver 116 and the optimal solution selector 118 are described in detail in connection with FIGS. 2 and 4.

In an aspect, an interface, not shown in FIG. 1, receives a vehicle routing problem. The interface can be a mathematical programming language (AMPL) interface. The interface can also be a linear programming (LP) interface. In an embodiment, the interface is a combination AMPL/LP interface. An AMPL interface can receive a vehicle routing problem specification (also referred to herein as a vehicle routing problem statement) and can transform that problem statement into a mathematical programming language (for example, Python). This transformed vehicle routing problem specification can then be translated into one or more equations (for example, quadratic equations) that can use a hybrid constrained quadratic model (CQM) that can be used in a quantum environment. An LP interface can receive a vehicle routing problem statement and can transform that vehicle routing problem statement into a linear language that can then be translated into one or more equations that can be used in a quantum environment. An AMPL/LP interface can use one or more mathematical programming languages and/or one or more linear programming languages to receive a problem statement and transform that problem statement into language that can then be translated into one or more equations that can be used in a quantum environment.

The interface can also be used to model complex constraints (for example, affinity and priority) using a modelling language. As used herein, a modelling language can be used to abstract the model (for example, of the vehicle routing problem) from the code implementation on the computing environment. By abstracting the model, a user can specify a problem in a modelling language without having to specify the problem using a specific application programming interface (API) or using a specific software development kit (SDK). The interface can perform conversion from a mathematical programming language or linear programming language into code that is compatible with a quantum environment.

As described herein, a vehicle routing problem can be sent from computing device 104, via network 110, to server 102. The cargo loading problem can be expressed as an objective function (also referred to as a criterion function, a fitness function, a cost function, a utility function, etc.) of an optimization problem. An objective function can be optimized, and this optimization is used to determine an optimal solution to a vehicle routing problem, subject to constraints including, but not limited to, those described herein. Decision variables of the objective function can specify the various constraints. Penalties of the objective function can also be used to penalize solutions that violate constraints.

In an aspect, not shown in FIG. 1, a generic modeling language parser, such as an LP parser, can be used to convert an LP file into, for example, Python code that can be used by a quantum computing environment and/or a high-performance computing environment to generate a solution to the vehicle routing problem, using systems and methods described herein. As an example, an LP parser can translate the vehicle routing problem into objectives and constraints that can be used by a quantum annealer, thereby abstracting the complexity of developing and debugging programs written in a specific programming language. The vehicle routing problem can also be partitioned into sub-problems, as described herein. As may be contemplated, the approach described herein, while described in terms of vehicle routing problems, may also be applicable to other models written in AMPL or LP.

In order to solve a vehicle routing problem, the route optimization system 112 can be used to determine an optimal solution to the vehicle routing problem using system and methods described herein. One measure of the complexity of a vehicle routing problem is the constraint density, which is the ratio between the number of variables and the number of constraints. As used herein, the constraint density of a problem is an indicator of the complexity of a problem. In some embodiments, when performing decomposition of a problem, the problem is decomposed into a set of smaller problems, each with a lower constraint density. In an aspect, the quantum architecture (for example, of the quantum provider) is limited by the maximum density ratio, which is a measure of the maximum number of variables and constraints allowed by the quantum device. In an aspect, the constraint density can be expressed as the ratio between the total number of variables and the total number of constraints:

$$τ = \frac{N \times L}{L + N + K + 1} \qquad ( 1 )$$

where τ is a measure of the model complexity, N is the total number of cargo blocks, L is the length of the payload area, and K is the number of cargo blocks (for example, of size 2), where 0≤K≤N. In equation (1), for the constraint density τ, it is assumed the total number of variables (for example, N×L) and the total number of constraints (for example, N+L+K+1) is compatible with the architecture constraint of the quantum solver, as described herein. The smaller the value of τ, the greater the probability that a quantum annealer can find a solution close to the ideal (possibly unknown) global optimal value.

As described herein, a solution to a vehicle routing problem can be found by using a clustering algorithm, described herein, provided by a clustering module 114. One example of a clustering algorithm is a Fuzzy C-Means clustering algorithm (FCM algorithm). Clustering can be divided into two categories: hard clustering and soft clustering. Hard clustering produces a rigid assignment of nodes to clusters, whereas soft clustering generates a list of membership values, denoting the affinity expressed by a node toward joining a specific cluster. Soft clustering allows for final assignment to be performed at a later stage, at which point the demand of a customer and the capacity of a truck can be considered. Fuzzy C-Means clustering can produce soft clusters.

The clustering algorithm described herein begins by randomizing the cluster centroids and the membership matrix, which defines the mapping of membership values from nodes to centroids. The cluster centroids and degree of membership are then updated repeatedly until convergence. The cluster centroids are updated based on the weighted average of the data points, where the weights represent the degrees of membership. The membership matrix is revised after each iteration based on the separation between each data point and each cluster centroid. The working of the algorithm can be explained as a sequence of the following six steps, described below. Additional details of this clustering algorithm are illustrated in FIG. 8.

Step one of the clustering algorithm includes the random initialization of data points. In step 1, for p clusters, each data point lies in all of the clusters with some membership value, which can be assumed to be anything in the initial state.

Step two of the clustering algorithm includes calculating the centroids. In step 2, the formula for calculating centroid V is:

$${V}_{j} = \frac{{\sum }_{k = 1}^{N} ( {γ}_{jk}^{m = 2} * {x}_{k} )}{{\sum }_{1}^{N} {γ}_{jk}^{m = 2}} \qquad ( 2 )$$

where γ is the fuzzy membership value of the data point, m is the fuzziness parameter (generally set at 2), xₖ is the data point, i is the cluster number, j is the coordinate (abscissa or ordinate of the cluster centroid), k is the data point number, and N is the total number of data points.

Step three of the clustering algorithm includes calculating distance from each point to the centroid. To calculate the distance of each point from the centroid, calculate the Euclidean distance d of each point from each centroid given by the formula:

$$d = \sqrt{{( {x}_{2} - {x}_{1} )}^{2} + {( {y}_{2} - {y}_{1} )}^{2}} \qquad ( 3 )$$

where (x₁, y₁) is the point in question and (x₂, y₂) is the centroid.

Step four of the clustering algorithm includes updating membership values. Given the formula:

$${γ}_{ik} = {[ {\sum }_{k = 1}^{N} {( \frac{{d}_{ki}^{2}}{{d}_{kj}^{2}} )}^{1 / m - 1} ]}^{- 1} \qquad ( 4 )$$

where i is the cluster number, j is the coordinate (abscissa or ordinate of the cluster centroid), k is the data point number, and N is the total number of data points.

Step five of the clustering algorithm repeats steps two, three, and four until the constant values of the member values are obtained or the value is less than the tolerance value. The tolerance value is the small value up to which the difference between the values of two consecutive updates is accepted. Its value can be assigned depending on the number of data points and clusters.

Step six of the clustering algorithm includes defuzzification of the membership values and assigning the nodes to the clusters with the help of the membership values. Modifications can be made to the FCM algorithm including, but not limited to, incorporating additional constraints and modifying the objective function to better reflect the problem requirements. The algorithm can create as many copies of the depot as there are clusters, before executing the FCM algorithm. In some aspects, the algorithm employs the elbow method using a sum of intra-cluster distances to select an optimal value of c, the number of clusters.

A clustering algorithm such as those described herein outputs a set of centroids rather than a set of medoids. The difference is that centroids may or may not be a member of the set of points, whereas medoids are required to be. That is, a medoid is, by definition, one of the points in the set of points while the centroid is not required to be one of the set of points. Thus, the denotation of the depot as centroid/medoid of all clusters is not mandatory, as that would detract from the ability of the assignment algorithm to perform an effective assignment. Cluster centroids that are located at a considerable distance from the depot may diminish the solution quality of the routing algorithm by increasing travel cost. In some implementations of clustering, a balance of different parameters is maintained. To maintain this balance, multiple instances of the depot can be incorporated into the algorithm by making the requisite number of copies of the depot, as many as there are clusters. This serves to provide additional weightage to the depot and thus skew the clusters so that the centroids are located closer to the depot than the actual center of the resulting clusters.

Turning now to FIG. 2, FIG. 2 is a block diagram 200 illustrating an example route optimization system 202 designed to solve a routing problem, in accordance with an aspect described herein. Systems in the form of H2S and H3S algorithms can be visualized using a pipeline, as detailed in FIG. 2, which consists of two main steps such as clustering and routing steps, as described herein. The route optimization system 202 comprises a VRP library instance 204, a clustering module 206, a quantum routing solver 210, and an optimal solution selector 214. The VRP library instance 204 is a code library that includes a collection of instances related to the vehicle routing problem (VRP) and/or the capacitated vehicle routing problem (CVRP). The library instance 204 can be an instance of VRPLib, PyVRP, and/or some other VRP library, that provides functions associated with VRP and CVRP problems (for example, reading, writing, and managing problems, and reading, writing, and managing solutions).

The VRP library instance 204 sends the problem parameters to the clustering module 206 that generates the cluster details 208. During clustering by the clustering module 206, customer nodes are assigned to clusters on the basis of both proximity to the cluster centroid and sufficient remaining cluster capacity to accommodate the requirements of the routing problem, as described below. Details of the clustering module 206 are described below in connection with FIG. 3. The clustering details 208, which can comprise k different clusters, are provided to a quantum routing solver 210 that uses techniques described herein to generate one or more feasible solutions 212. Details of the quantum routing solver 210 are described below in connection with FIG. 4. The feasible solutions 212, which can comprise n possible feasible solutions, are provided to an optimal solution selector 214, which selects a selected solution 216 based on one or more parameters, constraints, energy states, etc. The selected solution 216 is presented as the route optimization solution 218, which is the optimized solution to the VRP or CVRP parameters received from the VRP library instance 204. In some aspects, not shown in FIG. 2, a VRP library instance is used to manage the route optimization solution 218.

Although not illustrated in FIG. 2, in different routing problems, different clusters can be assigned to different vehicles. For example, in H2S, only a single cluster is assigned to a truck, so the capacity of each cluster is equal to that of each truck. Conversely, in H3S, multiple clusters can be assigned to each truck, so the capacity of each cluster is a fraction of that of each truck.

A solution of the routing problem can be generated using the example route optimization system 202 illustrated in FIG. 2. For the solution pipeline for H2S, each cluster is treated as a problem instance for the TSP and solved to obtain the optimal route covering all customers. The solution pipeline for H3S introduces an intermediary step between clustering and generating the solution of the TSP, which is the solution of a CVRP. In this intermediary step, a CV RP is formulated using the clusters obtained in the previous clustering step. The cluster centroids are treated as compressed nodes. These compressed nodes are treated as pseudo-customers. A solution of this CVRP results in an assignment of trucks (or other such vehicles) to nodes. The assigned clusters of each vehicle are then expanded into individual customer nodes. These individual nodes serve as the input for the TSP solver.

Differences between the steps for H2S and those for H3S are highlighted in Table 1, below.

TABLE 1
Differences between H2S and H3S

| Component | H2S Algorithm | H3S Algorithm |
|---|---|---|
| Classical FCM Clustering | Yes | Yes |
| Quantum CVRP Solver | No | Yes |
| Quantum TSP Solver | Yes | Yes |

FIG. 3 is a block diagram 300 illustrating an example route optimization clustering module 302, in accordance with an aspect described herein. FIG. 3 illustrates a first step in a solution pipeline as described above in connection with FIG. 2, corresponding to clustering module 206. The example route optimization clustering module 302 receives, as input, problem parameters 306 from a VRP library instance 304, which is a VRP library instance such as VRP library instance 204, described in connection with FIG. 2. The problem parameters 306 can include, for example, the number and location of customers and vehicles, as described above. The example route optimization clustering module 302 provides, as output, cluster details comprising a list of membership values of each customer associated with each cluster that is received. In some aspects, the cluster details 320 are a comma-separated value (CSV) file that indicates details of the k clusters, described above. The route optimization clustering module 302 provides the problem parameters 306 to an FCM module 308, which implements an FCM algorithm, described herein. The FCM module 308 generates soft clusters (or preferences) 310 to an assignment algorithm 312, which uses techniques described below to generate a set of final clusters 314. In some aspects, a cluster exporter 316 reformats the final clusters 314 to generate exported clusters 318. The exported clusters 318 comprise the cluster details 320, which are cluster details 404, described in connection with FIG. 4. The next steps of the solution pipeline are described in FIG. 4.

In FIG. 3, a processor such as those described herein performs an assignment algorithm 312. Input to the assignment algorithm 312 can include a net of nodes n with a corresponding set of membership values M={mᵢⱼ: 0≤mᵢⱼ≤1; mᵢⱼ∈R, i∈N, j∈C}, where R is the set of real numbers, representing affinities of each node n towards each cluster centroid cᵢ∈C.

Each cluster centroid is initialized with a capacity given by the equation:

$${capacity}_{cluster} = \frac{{capacity}_{truck}}{\frac{{n}_{clusters}}{{n}_{trucks}}} \qquad ( 5 )$$

where capacity_{cluster} is the capacity of a particular cluster, capacity_{truck} is the capacity of a particular truck, n_{clusters} is the number of clusters, and n_{trucks} is the number of trucks (or vehicles).

The assignment algorithm 312 is typically composed of two modules. The first module performs the assignment of nodes to preferred clusters and the second module causes the first module until it is complete. For the first module, assignment is made based on the soft clusters (preferences) 310. These preferences can include a “list of nodes” preference, can include a “find the cluster centroid with the highest preference for each node” preference, or can include other such preferences. For a “list of nodes” preference, a classical clustering is performed. For a “find the cluster centroid with the highest preference for each node” preference, clustering is performed to find the node with the highest preference. In this case, the first module then constructs a list for each cluster centroid with only nodes whose highest preference is that centroid, sorts the list in decreasing order of membership value, and adds nodes to each cluster's assignment array until capacity is met.

The assignment algorithm 312 begins by associating each node with its most preferred cluster centroid Cₚ:

$${C}_{p} = \{ {c}_{j} : {m}_{ij} = max ( {m}_{ij} ) ∀ i ∈ N , j ∈ C , {c}_{j} ∈ C \} \qquad ( 6 )$$

Then, for each cluster centroid, a list of nodes Nⱼ that have centroid cⱼ as their most preferred centroid is generated. These lists are sorted in descending order of membership value. Then, for each centroid, each node in its corresponding list of nodes Nⱼ is iteratively assigned to the centroid's cluster, the demand corresponding to the node being subtracted from the cluster's capacity. Once the current cluster has insufficient capacity to accommodate the next node in its list, the next centroid cⱼ₊₁ is considered. This continues, for all cⱼ∈C. This assignment algorithm is run in a loop, where each iteration eliminates the most preferred centroid from the list of available candidates for each unassigned node. The loop terminates once all nodes have been assigned.

The solution space to an optimization problem can be represented using Hamiltonians. Using Hamiltonians, the solution space to an optimization problem can be represented as an energy landscape in n-dimensional space where peaks are associated with high energy values and valleys are associated with low energy values. A Hamiltonian is a mathematical operator used to represent the total energy contained within a physical system. Hamiltonians are used to seek and settle in a stable state with the lowest possible energy. Quantum annealing seeks to exploit this natural tendency to guide the solution away from the peaks of the energy landscape and towards the valleys. This minimizing of the system's Hamiltonian. A lower value of the Hamiltonian indicates a more optimal solution than a higher value. Therefore, if the objective function of an optimization problem can be represented in the form of a Hamiltonian, the problem becomes one of minimization.

A solution to an optimization problem satisfies the constraints associated with the problem. In order to accommodate them in the energy landscape, constraints can be transformed instead into penalties and included in the objective function. A penalty introduces a large positive value into the objective function if the constraint is violated, thereby rendering the solution less optimal. Constraints can be either in the form of an equation or an inequality. Thus, the penalties must be formulated to model the constraints accurately.

FIG. 4 is a block diagram 400 illustrating an example quantum routing solver 402, in accordance with an aspect described herein. As illustrated in FIG. 4, quantum annealing is a quantum computing methodology that uses the laws of quantum mechanics to solve optimization problems, as presented in FIG. 4. As described herein, quantum annealing can be well-suited to handle difficult combinatorial optimization problems, requiring simultaneous evaluation of several potential solutions. The quantum routing solver 402 receives cluster details 404 comprising the location and demand of customers 406 and, from a VRP library instance 408, available capacity 410. The VRP library instance 408 is a VRP library instance such as VRP library instance 204, described in connection with FIG. 2 and the available capacity 410 is the available vehicle capacity which can be specified as problem parameters 306, described above in connection with FIG. 3.

The quantum routing solver 402 uses the cluster details 404 comprising the location and demand of customers 406 and the available capacity 410 to formulate objectives and constraints of the routing problem, as described below. The quantum routing solver 402 then performs binarization 414, which is a process that converts data to binary format (having values of 0 or 1). Binarization 414 simplifies the processing, and is used as described below, in connection with the various constraints. The quantum routing solver 402 then performs unconstraining 416, which transforms inequality constraints such as those described below into equations using Lagrange parameters. The quantum routing solver 402 then performs quadratization 418, which is a process to reduce the degree-3 and degree-4 monomials so that they can be directly mapped to QUBO problems. The quantum routing solver 402 then performs embedding 420, which embeds the result of the quadratization 418, if necessary, within a stochastic gradient descent so that the quantum annealing can be performed. The quantum routing solver 402 then performs quantum annealing 422, which is described below to generate the feasible solutions 424, which are the n feasible solutions 212, described above in connection with FIG. 2.

As described herein, combinatorial optimization issues for quantum annealing are typically modelled mathematically using quadratic unconstrained binary optimization (QUBO). This gives users a means to communicate optimization issues in a way that quantum annealing software and hardware can use. A quadratic function with binary variables with values of 0 or 1 can be minimized in a QUBO problem. Operations to perform binarization 414 can generate a quadratic function with binary variables with values of 0 or 1 that can be minimized in a QUBO problem. QUBO equations can consist of two components such as, for example, an objective function and various constraint functions. The general form of a QUBO problem is:

$$minimum f ( x ) = {x}^{T} Qx \qquad ( 7 )$$

where x is a vector of primary values representing the constraints considered such that: xᵢ∈{0,1}, where Q is a matrix (for example, a symmetric matrix) representing the objective function, and x^{T} denotes the transpose of vector x.

From the previous clustering step described in FIG. 3, a set of clusters is obtained with one or more customer nodes assigned to them. Each cluster can have a centroid located at the arithmetic mean of coordinates of all assigned nodes. Each cluster can also have an associated aggregate demand that is representative of the sum of demands of all assigned customer nodes. Cluster centroids can be considered to be compressed pseudo-customer nodes, as described above. The location of the pseudo-customers can correspond to the location of the centroids, and the demand can correspond to the aggregate demand of the centroid's cluster. This is modelled as a CVRP instance to be solved by the QA CVRP solver. In some aspects, this step occurs only for H3S, and not for H2S, as described above with respect to Table 1.

To solve the CVRP using a QUBO formulation, the objective function and accompanying constraints described below can be used. This function and these constraints can accurately represent the problem's requirements in terms of optimality and feasibility, respectively.

The decision variables of the optimization problem are used to represent the path traversed by each truck. They can be defined as x_{r,i,j} and s_{i,r} where:

$${x}_{r , i , j} = \{ \begin{matrix}1 : truck r traverses edge ( i , j ) \\ 0 : truck r does not traverse edge ( i , j )\end{matrix} \qquad ( 8 )$$

$$and$$

$${s}_{i , r} = \{ \begin{matrix}1 : node i is visited by truck r \\ 0 : node i is not visited by truck r\end{matrix} \qquad ( 9 )$$

The objective function of the optimization problem can then be defined as:

$$min ( {\sum }_{r = 0}^{p - 1} {\sum }_{i = 0}^{n - 1} {\sum }_{j = 0}^{n - 1} {c}_{i , j} * {x}_{r , i , j} ) \qquad ( 10 )$$

where c_{i,j} is the cost for the edge (i,j). This provides the basis for the operations to formulate the objective and constraints 412. The operations to formulate the objective and constraints 412 also include the generation of the five constraints, described below, which may be expressed as a mathematical formulation or as a Hamiltonian equation.

A first constraint, that each node is visited only once, by at most one truck, is imposed. This constraint can be expressed as a mathematical formulation:

$${\sum }_{i = 0 , i \neq j}^{n - 1} {\sum }_{r = 0}^{p - 1} {x}_{r , i , j} = 1 , ∀ j ∈ N \qquad ( 11 )$$

and as a Hamiltonian equation:

$$H = {\sum }_{i = 0 , i \neq j}^{n - 1} {( {\sum }_{i = 0 , i \neq j}^{n - 1} {\sum }_{r = 0}^{p - 1} {x}_{r , i , j} - 1 )}^{2} \qquad ( 12 )$$

Then, for any destination node j, excluding node 0 (the depot, which will be visited once by each truck), a summation is set up so that X_{r,i,j}=1 for only a single value of i, across all trucks r. If this holds for all nodes j, H will have the minimum possible value of 0.

A second constraint, that each truck leave the depot (for example, node 0) is imposed. This constraint can be expressed as a mathematical formulation:

$${\sum }_{r = 0}^{p - 1} {\sum }_{j = 0}^{n - 1} {x}_{r , 0 , j} = 1 \qquad ( 13 )$$

and as a Hamiltonian equation:

$$H = {\sum }_{r = 0}^{p - 1} {( {\sum }_{j = 1}^{n - 1} {x}_{r , 0 , j} - 1 )}^{2} \qquad ( 14 )$$

Here, the source node i is set to the constant value of 0, denoting the depot. In some aspects, for every truck, X_{r,o,j}=1, only a single value of j ensures H is at its minimum value of 0. This signifies that only one edge with the depot as the source is traversed and thus the truck only leaves the depot once.

A third constraint, that each truck must have a valid route (for example, that if a truck visits node n, the truck must next leave node n) is imposed. This constraint can be expressed as a mathematical formulation:

$${\sum }_{j = 0}^{n - 1} {\sum }_{r = 0}^{p - 1} {\sum }_{i = 0}^{n - 1} ( {x}_{r , j , i} - {\sum }_{k = 0}^{n - 1} {x}_{r , j , k} ) = 0 , ∀ i \neq j \neq k \qquad ( 15 )$$

and as a Hamiltonian equation:

$$H = {\sum }_{j = 0}^{n - 1} {\sum }_{r = 0}^{p - 1} {( {\sum }_{i = 0 , i \neq j}^{n - 1} {x}_{r , i , j} - {\sum }_{i = 0 , i \neq j}^{n - 1} {x}_{r , i , j} )}^{2} \qquad ( 16 )$$

This constraint ensures that if a truck r enters node j from some node i^{(x}^{_{r,i,j}}⁼¹⁾, it must also leave node j to some other node i^{(x}^{_{r,i,j}}⁼¹⁾. It should be noted that this constraint does allow for a loop from node i to node j and then back to i. This constraint is used in conjunction with the fifth constraint, described below, to prevent this potentially undesirable occurrence.

A fourth constraint, that a capacity of a truck is not exceeded, is imposed, as described herein. This constraint can be expressed as a mathematical formulation:

$${\sum }_{j = 0}^{n - 1} {\sum }_{i = 0}^{n - 1} {D}_{j} * {x}_{r , i , j} \leq Q , ∀ j \neq i , r in [ 0 , p ) \qquad ( 17 )$$

and as a Hamiltonian equation:

$$H = {\sum }_{j = 0}^{n - 1} [ {\sum }_{j = 1}^{n - 1} {\sum }_{i = 0}^{n - 1} ( {D}_{j} * {x}_{r , i , j} ) - Q ] \qquad ( 18 )$$

where Dⱼ is the demand of the node j and Q is the capacity of each truck. This constraint ensures that, for each truck r, the demand of node j is considered in the summation if it is the distance of an edge included in the truck's route (for example, when x_{r,i,j}=1). This quantity represents the total demand a truck can fulfill. In some aspects, an inequality is set up by subtracting the capacity of the truck from this, ensuring that the capacity is greater than total demand. In some aspects, a large positive value is added to the objective function by means of the Lagrange parameter associated with this constraint.

A fifth constraint, that a sequence of steps be followed, is imposed. This constraint eliminates sub-tours for each truck. As used herein, a sub-tour is a circuit of a graph that does not include the depot (for example, node 0). This constraint can be expressed as a mathematical formulation:

$${\sum }_{i = 1}^{n - 1} {\sum }_{j = 1 , j \neq i}^{n - 1} {\sum }_{r = 0}^{p - 1} s [ j ] [ k ] - ( s [ i ] [ k ] + 1 ) + B * ( 1 - x [ k ] [ i ] [ j ] ) \qquad ( 19 )$$

and as a Hamiltonian equation:

$$H = {\sum }_{i = 1}^{n - 1} {\sum }_{j , j = 1 , j \neq i}^{n - 1} {\sum }_{r = 0}^{p - 1} - [ {s}_{j , r} - ( {s}_{i , r} + 1 ) + B * ( 1 - {x}_{r , i , j} ) ] \qquad ( 20 )$$

In this constraint formulation, a second binary decision variable s is introduced, denoting the step in the sequence of routes that a node is traversed by a particular truck. In some aspects, a mapping between x and s is introduced in the second part of the equation, where B is a tunable parameter. In some aspects, if X_{i,j,k}=1, a negative value of H (desirable) is contingent on node j being visited after node i. if X_{i,j,k}=0, the large value of B that results ensures that the value of H is negative.

It should be noted that the objective function and the constraints described herein used for the CVRP can be used for the TSP (except for the demand constraint, which may not be valid). This is because the CV RP is a generalization of the TSP where there is just one truck that acts as a stand-in for the salesman, and the demand constraint can thus be removed as it has already been accounted for in the clustering phase.

FIG. 5 is a block diagram illustrating an example quantum annealer 500, in accordance with an aspect described herein. As FIG. 5 is only one example, other quantum annealers may be employed, some examples of which may include other annealers employing superconducting qubits to find the optimal or near-optimal ground state solutions for solving proposed optimization problems. As such, other quantum annealers having more or fewer components, and having different arrangements or architectures, can be used. The quantum annealer 500 illustrated in FIG. 5 is an example and it is provided to aid in the description of the technology rather than to limit the technology to one type of quantum annealer, or any type of quantum computing system. In the example provided, quantum annealer 500 comprises control system 502 operationally coupled to QPU 504, readout instruments 506, and magnetic field generator 508.

The control system 502 of the quantum annealer 500 generally interfaces with components of quantum annealer 500, including QPU 504, readout instruments 506, and magnetic field generator 508, among other components not illustrated. For instance, control system 502 may operationally control or receive information from such components. In some aspects, control system 502 facilitates quantum annealing functions, for example, translating a quantum problem into physical aspects of the QPU 504; setting parameters of the quantum annealing process, including the biases and couplings among qubits; managing the annealing schedule, a predefined protocol guiding the system from the initial to the final Hamiltonian that finds the global minimum representing the quantum problem's solution; among other functions and operations.

During an annealing process, the control system 502 generates and delivers signals to the qubits and couplers of QPU 504, manipulating their states and interactions in accordance with the quantum problem being executed. As the annealing process concludes, control system 502 can oversee the readout of qubits' states in coordination with readout instruments 506, thus translating quantum information into classical data that can be interpreted by classical computing devices.

The control system 502 can communicate with one or more external systems using a network 510 by communicatively coupling with other computing devices, such as computing device 1100 of FIG. 11, to facilitate the input of problem definitions and the output of solutions. The control system 502 can comprise a classical computer processor that reads from memory to execute computer-readable instructions stored thereon.

The QPU 504 is a Quantum Processing Unit that is the core of quantum computational activity. The QPU 504 can house an array of qubits (quantum bits), which may exist in a superposition of states. The QPU 504 can facilitate quantum operations that exploit quantum phenomena like superposition and entanglement to solve quantum problems. As used herein, superposition is the ability of a quantum system to be in multiple states at the time it is measured or sampled. As used herein, entanglement is the property that the quantum state of particles in a group of particles cannot be described independently of each other, even at great spatial separation. The QPU 504 can facilitate quantum operations that exploit other quantum phenomena. Within the QPU 504, couplers can manage interactions between the qubits and form the basis for quantum logic gates and multi-qubit operations for quantum algorithms. Although not illustrated, the QPU 504 can be cooled by a cooling device of quantum annealer 500 and shielded from other external components or interferences, helping to maintain quantum coherence.

The QPU 504 can comprise control lines, across which signals are transmitted that guide quantum operations of QPU 504. The QPU 504 can couple to readout instruments 506 to translate quantum states into classical data and communicate control system 502. The readout instruments 506 can include an analog-to-converter that translates the quantum state of the qubits to the digital space, thereby identifying the quantum state of the qubits in a manner readable by a classical machine, and thus providing a candidate solution for the quantum problem to control system 502. The analog signals captured from qubit measurements can be amplified and filtered to sift through and eliminate noise before being provided to readout instruments 506.

The qubit states can be manipulated by control system 502 employing magnetic field generator 508. By varying the strength and orientation of the magnetic field, control system 502 can tailor the energy landscape that the qubits navigate during the annealing process. This magnetic field can induce a bias on each qubit, influencing its tendency to take on a particular state during the annealing process.

In some embodiments, the construction of quantum computers can be approached through various paradigms and hardware setups, among which gate-based quantum computing and adiabatic quantum computation (AQC) are predominant. Gate-based computing involves executing computations by applying a series of unitary gates to quantum bits (qubits), which are then measured at the computation's conclusion. Conversely, AQC starts with a many-qubit quantum state prepared as a simple Hamiltonian's ground state, which, through adiabatic time evolution, transitions to a final Hamiltonian, encoding the solution to a targeted optimization problem. AQC and gate-based quantum computing are polynomially equivalent since quantum circuits can be depicted as a time-dependent Hamiltonian with a maximal polynomial overhead.

As used herein, quantum annealing (QA) is closely related to AQC. QA is a variant of the AQC model, employed when adiabatic conditions are unfulfilled, leading to a heuristic variational quantum algorithm. This technique is adept at identifying the ground state of Ising models, an NP-hard challenge. NP-hard and NP-complete combinatorial optimization problems such as the TSP and the CVRP can be transformed to forms suitable for quantum annealers, either framed in Ising form or as a Quadratic Unconstrained Binary Optimization (QUBO) problem. For instance, these optimization problems can be transformed to Ising form using a {−1, 1} basis and spin variables or as a QUBO problem using the {0, 1} basis and binary variables using binarization, as described herein. In QA, solving an optimization problem entails progressing through multiple stages, with the specifics of each stage being influenced by the kind of qubits utilized, the adiabatic protocol implemented, and other engineering factors.

FIG. 6 is a block diagram 600 illustrating an example quantum annealing process in an aspect described herein. The example process illustrated in FIG. 6 can be performed by the example quantum annealer 500 described in connection with FIG. 5. The example quantum annealing process illustrated in FIG. 6 is only one example provided as an aid for understanding and using the technology described herein. The quantum annealer 604 is a quantum annealer such as quantum annealer 500, described herein at least in connection with FIG. 5. At a high level, the quantum annealer 604 receives an input, illustrated using example quantum problem 602, and outputs candidate solution(s) 606. Quantum annealing process 600 illustrates steps 608-614 (described below) that may be performed by or for quantum annealer 604 to determine solution(s) 606. For instance, some aspects may be performed by a computing device 620 communicatively coupled to quantum annealer 604. As an example, the computing device 620 may be used to facilitate aspects of minor embedding process 608, programming process 610, initialization process 612, and/or annealing process 614 in coordination with quantum annealer 604. The computing device 620 is a computing device such as computing device 1100 described in connection with FIG. 11. The computing device 620 can interface with a control system (for example, control system 502) of quantum annealer 604, which can be the same or a separate computing device, as described above in connection with FIG. 5. As with other aspects of FIG. 6, each of the processes 608-618 is intended to represent an example, and is not intended to restrict the technology to a particular process or machine.

Having this in mind, quantum problem 602 may include optimization problems in various forms, such as a QUBO model and an Ising model. In some aspects, real-world problems can be broken down into objectives and constraints, as described herein. Optimization problems can be represented by the following QUBO form:

$$min ( {\sum }_{i} {a}_{i} {x}_{i} + {\sum }_{i} {\sum }_{j > 1} {b}_{i , j} {x}_{i} {x}_{j} + c ) \qquad ( 21 )$$

where the binary variables xᵢ and xⱼ can take values from {0, 1}, and aᵢ, bᵢ, and c are constraints defined by the problem to be solved.

Optimization problems can also be expressed by the Ising model, taking the following form:

$$min ( {\sum }_{i} {h}_{i} {s}_{i} + {\sum }_{i} {\sum }_{j > 1} {J}_{i , j} {s}_{i} {xs}_{j} ) \qquad ( 22 )$$

where the variables sᵢ and sⱼ may take values from {−1, 1}, and J_{i,j} is the interaction of two adjacent sites <i,j> for a given magnetic field hᵢ. As may be contemplated, the QUBO form and the Ising form can be translated from one another in some cases.

As described herein, these models can be represented by a logical graph. For example, for a QUBO problem, each node may correspond to a variable that may correspond to qubits, and edges of this graph represent the interaction terms between pairs of variables, derived from the quadratic terms in the QUBO expression. Similarly, for an Ising model, each node may represent a spin and correspond to qubits, and edges may denote the interactions between pairs of spins (or variables) as dictated by the interaction terms in the Ising model's energy expression. Such models may be formulated or represented as a logical graph and provided as a quantum problem 602 to quantum annealer 604.

During the minor embedding process 608, the local graph of the initial quantum problem 602 may be translated onto the physical hardware of the QPU (for example, QPU 504). Here, select sets of physical qubits represent the nodes, while couplings between the qubits (for example, the edges) correspond to the interaction of the logical variables.

During the programming process 610, the quantum annealer 604 can be programmed with the parameters that define the problem. This problem may be the final Hamiltonian. As used herein, the final Hamiltonian is a quantum mechanical operator that represents the problem to be solved in a form that quantum annealer 604 can utilize to generate a solution. In some aspects, the final Hamiltonian is derived from the logical representation of the problem (such as the QUBO formulation or the Ising model). The objective here is to find the state (or configuration of qubits) that minimizes its energy as this corresponds to the solution of quantum problem 602.

The programming process 610 can comprise setting weights for each qubit bias and coupler strength. The qubits in quantum annealer 604 can have a bias, for example, a term in the final Hamiltonian that represents an external magnetic field acting on the qubit. Setting the bias on a qubit influences its tendency to take a particular state (0 or 1). Weights for the qubit bias may be set based on the problem formulation to guide quantum annealer 604 toward the solution. Couplers can comprise elements in quantum annealer 604 that control the interaction between pairs of qubits. The strength of a coupler determines the extent to which the state of one qubit influences the state of another. Coupler strength can be set to represent the interactions between variables in quantum problem 602.

During initialization process 612, an initial Hamiltonian may be defined. The initial Hamiltonian may be constructed to have an achievable lowest energy (ground state) configuration. In some aspects, this definition of initial Hamiltonian serves as a starting point for the annealing process 614.

Through the annealing process 614, the quantum annealer 604 transitions from the initial Hamiltonian to the final Hamiltonian (which was defined during the programming phase and represents the problem to be solved). Generally, as the system transitions, quantum annealer 604 attempts to maintain the lowest-energy configuration, and ideally ends in the ground state of the final Hamiltonian, which corresponds to the solution of the quantum problem 602. In some cases, annealing process 614 can also be combined with a reverse annealing phase, which initializes quantum annealer 604 with a known initial solution and searches the state space around this solution, which represents a local optimum solution using techniques described herein.

At the end of the annealing process 614, the quantum annealer 604 provides candidate solutions 616 (for example, possible solutions to the quantum problem 602). Here, the qubits in the QPU are in an eigenstate or a superposition of eigenstates with respect to the final Hamiltonian. An eigenstate refers to a state with a well-defined energy and represents a possible solution. A superposition of eigenstates refers to multiple eigenstates at once, each representing a potential solution to the problem. Each qubit's spin (either up or down) is read out, and the collection of spin values represents a candidate solution to quantum problem 602.

It should be noted that quantum annealing is heuristic and the exact optimal solution (ground state of the final Hamiltonian) may not be found in every run. Instead, the candidate solutions 616 can provide a good enough solution in a reasonable amount of time. Naturally, there's a non-zero probability of ending up in a non-optimal solution due to various quantum phenomena like tunneling and thermal fluctuations. As such, annealing process 614 may undergo resampling 618, which repeats the annealing process 614 in an effort to identify a better solution than prior candidate solutions 616. Each resampling process provides a new opportunity for the quantum annealer 604 to explore the solution space and possibly find a better or different candidate solution. Resampling 618 may be performed as many times as desired, as time and continued benefit allow. By comparing candidate solutions 616, the best candidate solution or even a variety of candidate solutions may be chosen as solutions to quantum problem 602 and output as final solution(s) 606.

FIG. 7 is a flow diagram 700 illustrating an example process for generating a solution to a route optimization problem, in accordance with an aspect described herein. The process illustrated in flow diagram 700 can be performed using the route optimization system 112 using GPUs 108 and/or other such processors. Accordingly, a clustering module 114, a quantum routing solver 116, and/or an optimal solution selector 118 can perform one or more steps of the flow diagram 700 illustrated in FIG. 7 to determine an optimal vehicle routing solution, as described herein. As may be contemplated, the example process illustrated in FIG. 7 is intended to provide one illustrated example of the technology described herein and other processes and/or methods may be realized. Each step of the process illustrated in flow diagram 700 can comprise a computing process performed using any combination of hardware, firmware, or software. For instance, various functions can be carried out by a processor executing instructions stored in memory such as that described in connection with FIG. 11. The process illustrated in flow diagram 700 can also be embodied as computer-usable instructions stored on computer storage media such as that described in connection with FIG. 11. The process illustrated in flow diagram 700 can be provided by a standalone application, a service or hosted service (standalone or in combination with another hosted service), or a plug-in to another product, to name a few possibilities. The process illustrated in flow diagram 700 can be implemented in whole or in part by components of operating environment 100, such as a route optimization system 112, a clustering module 114, a quantum routing solver 116, and/or an optimal solution selector 118, among other components or functions not illustrated.

At step 702 of the process for generating a solution to a route optimization problem illustrated in flow diagram 700, a processor such as those described herein performs operations to receive problem parameters for a route optimization problem where the route optimization problem has a solution space that is larger than a solution space threshold for simulated annealing. In some aspects, the problem parameters are received from a VRP library instance such as VRP library instance 304. In some aspects, the problem parameters are problem parameters such as problem parameters 306. In some aspects, the simulated annealing is quantum annealing. In some aspects, after step 702, the process illustrated in flow diagram 700 continues at step 704.

At step 704 of the process for generating a solution to a route optimization problem illustrated in flow diagram 700, a processor such as those described herein performs operations to perform clustering using the problem parameters of the route optimization problem to reduce the solution space of the route optimization problem received at step 702. In some aspects, the operations to perform clustering of step 704 are performed by the clustering module 114. In some aspects, the operations to perform clustering of step 704 are performed by the clustering module 206. In some aspects, the operations to perform clustering of step 704 are performed by the route optimization clustering module 302. In some aspects, the operations to perform clustering of step 704 are operations of an FCM algorithm implemented by an FCM module 308. In some aspects, the operations to perform clustering of step 704 are operations of the process illustrated in flow diagram 800, described below. In some aspects, after step 704, the process illustrated in flow diagram 700 continues at step 706.

At step 706 of the process for generating a solution to a route optimization problem illustrated in flow diagram 700, a processor such as those described herein performs operations to perform routing using the results of the clustering performed at step 704. In some aspects, the operations to perform routing of step 706 are performed by a quantum routing solver 116. In some aspects, the operations to perform routing of step 706 are performed by a quantum routing solver 210. In some aspects, the operations to perform routing of step 706 are performed by a quantum routing solver 402. In some aspects, after step 706, the process illustrated in flow diagram 700 continues at step 708.

At step 708 of the process for generating a solution to a route optimization problem illustrated in flow diagram 700, a processor such as those described herein performs operations to receive feasible solutions by performing simulated annealing using the reduced solution space, the simulated annealing initialized with an initial solution based on the problem parameters. In some aspects, as described above, the simulated annealing is quantum annealing. In some aspects, at step 708, the simulated annealing step is initialized with an initial solution based on the constraints determined at step 702. In some aspects, the simulated annealing of step 708 is as described with respect to performing quantum annealing 422. In some aspects, the simulated annealing of step 708 is performed using quantum annealer 500. In some aspects, the simulated annealing of step 708 is performed using quantum annealer 604. In some aspects, after step 708, the process illustrated in flow diagram 700 continues at step 710.

At step 710 of the process for generating a solution to a route optimization problem illustrated in flow diagram 700, a processor such as those described herein performs operations to recombine the plurality of solutions determined at step 708 to generate a solution to the route optimization problem. In some aspects, the operations to recombine the plurality of solutions determined at step 708 to generate a solution to the route optimization problem are performed by a route optimization system 112 and/or by a route optimization system 202. In some aspects, after step 710, the process illustrated in flow diagram 700 continues at step 712.

At step 712 of the process for generating a solution to a route optimization problem illustrated in flow diagram 700, a processor such as those described herein performs operations to provide the solution to the route optimization problem generated at step 710 via a user interface using a computing device such as computing device 104. In an aspect, after step 712, the process illustrated in flow diagram 700 terminates. In some aspects, not shown in FIG. 7, after step 712, the process illustrated in flow diagram 700 continues at step 702 to determine a new set of constraints for a route optimization problem, which can be the same route optimization problem or a new route optimization problem.

In some aspects, the steps of the process (or method) illustrated in flow diagram 700 can be performed in a different order than that illustrated in FIG. 7. For example, a step that does not rely on the results of another step can be performed before, after, or concurrently with that other step. In another example, one or more steps of the process illustrated in flow diagram 700 can be performed concurrently or in parallel by a plurality of threads operating on a computing system such as that illustrated in connection with FIG. 1.

FIG. 8 is a flow diagram illustrating an example process 800 for performing clustering, in accordance with an aspect described herein. The process illustrated in flow diagram 800 can be performed using the route optimization system 112 using GPUs 108 and/or other such processors. Accordingly, clustering module 114 can perform one or more steps of the flow diagram 800 illustrated in FIG. 8 to perform clustering in association with determining an optimal vehicle routing solution, as described herein. As may be contemplated, the example process illustrated in FIG. 8 is intended to provide one illustrated example of the technology described herein and other processes and/or methods may be realized. Each step of the process illustrated in flow diagram 800 can comprise a computing process performed using any combination of hardware, firmware, or software. For instance, various functions can be carried out by a processor executing instructions stored in memory such as that described in connection with FIG. 11. The process illustrated in flow diagram 800 can also be embodied as computer-usable instructions stored on computer storage media such as that described in connection with FIG. 11. The process illustrated in flow diagram 800 can be provided by a standalone application, a service or hosted service (standalone or in combination with another hosted service), or a plug-in to another product, to name a few possibilities. The process illustrated in flow diagram 800 can be implemented in whole or in part by components of operating environment 100, such as a route optimization system 112 and/or a clustering module 114, among other components or functions not illustrated.

At step 802 of the process to perform clustering illustrated in flow diagram 800, a processor such as those described herein performs operations to initialize random data points. At step 802, for p clusters, each data point lies in all of the clusters with some membership value, which can be assumed to be anything in the initial state, as described above. In some aspects, after step 802, the process illustrated in flow diagram 800 continues at step 804.

At step 804 of the process to perform clustering illustrated in flow diagram 800, a processor such as those described herein performs operations to calculate centroids using Equation (2), described above. In some aspects, after step 804, the process illustrated in flow diagram 800 continues at step 806.

At step 806 of the process to perform clustering illustrated in flow diagram 800, a processor such as those described herein performs operations to calculate the distance from each point to the centroid using Equation (3), described above. In some aspects, after step 806, the process illustrated in flow diagram 800 continues at step 808.

At step 808 of the process to perform clustering illustrated in flow diagram 800, a processor such as those described herein performs operations to update membership values using Equation (4), described above. In some aspects, after step 808, the process illustrated in flow diagram 800 continues at step 810.

At step 810 of the process to perform clustering illustrated in flow diagram 800, a processor such as those described herein performs operations to determine whether the constant values of the membership values are less than a tolerance value. The tolerance value is a small value up to which the difference between the values of two consecutive updates is accepted. The tolerance value can be assigned depending on the number of data points and clusters. The tolerance value can also be specified as a parameter to the clustering algorithm. If it is determined, at step 810, that the constant values of the membership values are less than the tolerance value (the “YES” branch), the process illustrated in flow diagram 800 continues at step 812. If it is determined, at step 810, that the constant values of the membership values are not less than the tolerance value (the “NO” branch), the process illustrated in flow diagram 800 continues at step 804 to calculate new centroids.

At step 812 of the process to perform clustering illustrated in flow diagram 800, a processor such as those described herein performs defuzzification of the membership values. In some aspects, not shown in FIG. 8, after step 810 of the process to perform clustering illustrated in flow diagram 800, a processor such as those described herein assigns the nodes to the clusters with the help of the membership values. As described above, other modifications can be made to the process to perform clustering including, but not limited to, incorporating additional constraints and modifying the objective function to better reflect the problem requirements. For example, the process to perform clustering illustrated in flow diagram 800 can create as many copies of the depot (Node 0) as there are clusters before executing the clustering algorithm. This can simplify the problem or facilitate a more efficient solution, as described above. In some aspects, the algorithm employs the elbow method using the sum of intra-cluster distances to select an optimal value of the number of clusters. In some aspects, after step 812, the process illustrated in flow diagram 800 terminates. In some aspects, not shown in FIG. 8, after step 812, the process illustrated in flow diagram 800 continues at step 802 to initialize a new set of random data points.

In some aspects, the steps of the process (or method) illustrated in flow diagram 800 can be performed in a different order than that illustrated in FIG. 8. For example, a step that does not rely on the results of another step can be performed before, after, or concurrently with that other step. In another example, one or more steps of the process illustrated in flow diagram 800 can be performed concurrently or in parallel by a plurality of threads operating on a computing system such as that illustrated in connection with FIG. 1.

FIG. 9 is a block diagram 900 illustrating example routes using a hybrid three-step (HS3) algorithm. FIG. 9 depicts thirty-two customers, designated by Node ‘0’ to Node ‘31’ that have been assigned to different clusters (cluster 904, cluster 906, cluster 908, cluster 910, and cluster 912) which are serviced by, for example, five trucks. In FIG. 9, Node ‘0’ 902 represents the depot from which each truck forms closed loops, leaving and returning only once and, as such, Node ‘0’ 902 is included in each of the clusters (cluster 904, cluster 906, cluster 908, cluster 910, and cluster 912). As illustrated, each loop portrays an individual cluster that may be optimal.

Cluster 904 includes Node ‘20’, Node ‘27’, Node ‘24’, and Node ‘14’, and the vehicle for cluster 904 goes from Node ‘0’ 902 to Node ‘20’, then to Node ‘27’, then to Node ‘24’, then to Node ‘14’, and then back to Node ‘0’ 902.

Cluster 906 includes Node ‘5’, Node ‘25’, Node ‘10’, Node ‘15’, Node ‘29’, Node ‘22’, Node ‘9’, Node ‘18’, and Node ‘6’, and the vehicle for cluster 906 goes from Node ‘0’ 902 to Node ‘5’, then to Node ‘25’, then to Node ‘10’, then to Node ‘15’, then to Node ‘29’, then to Node ‘22’, then to Node ‘9’, then to Node ‘18’, then to Node ‘6’, and then back to Node ‘0’ 902.

Cluster 908 includes Node ‘8’, Node ‘11’, Node ‘4’, Node ‘28’, Node ‘23’, Node ‘3’, and Node ‘2’, and the vehicle for cluster 908 goes from Node ‘0’ 902 to Node ‘8’, then to Node ‘11’, then to Node ‘4’, then to Node ‘28’, then to Node ‘23’, then to Node ‘3’, then to Node ‘2’, and then back to Node ‘0’ 902.

Cluster 910 includes Node ‘30’, Node ‘26’, Node ‘16’, Node ‘1’, and Node ‘12’, and the vehicle for cluster 910 goes from Node ‘0’ 902 to Node ‘30’, then to Node ‘26’, then to Node ‘16’, then to Node ‘1’, then to Node ‘12’, and then back to Node ‘0’ 902.

Cluster 912 includes Node ‘7’, Node ‘13’, Node ‘17’, Node ‘19’, Node ‘31’, and Node ‘21’, and the vehicle for cluster 912 goes from Node ‘0’ 902 to Node ‘7’, then to Node ‘13’, then to Node ‘17’, then to Node ‘19’, then to Node ‘31’, then to Node ‘21’, and then back to Node ‘0’ 902.

As may be contemplated, there are certain cases where a node can be wrongly assigned to a cluster, decreasing the optimal solution. For example, Node ‘6’ 914 has been assigned to cluster 906 but could be more optimally included in cluster 908, or cluster 910, or cluster 912.

FIG. 10 is a block diagram 1000 illustrating example routes using a hybrid two-step (HS2) algorithm. The conditions depicted in FIG. 10 are the same as those depicted in FIG. 9 but with some nodes included in different clusters due to the different algorithm. As with FIG. 9, FIG. 10 depicts thirty-two customers, designated by Node ‘0’ to Node ‘31’ that have been assigned to different clusters (cluster 1004, cluster 1006, cluster 1008, cluster 1010, and cluster 1012) which are serviced by, for example, five trucks. In FIG. 10, Node ‘0’ 1002 represents the depot from which each truck forms closed loops, leaving and returning only once and, as such, Node ‘0’ 1002 is included in each of the clusters. As illustrated, each loop portrays an individual cluster that may be optimal. Detailed descriptions of the clusters, Nodes, and routes illustrated in FIG. 10 are omitted here.

FIG. 10 shows that the route shown for cluster 1004, that includes Node ‘20’, Node ‘27’, Node ‘24’, Node ‘14’, Node ‘6’, and Node ‘2’ appears to cross other routes (for example, the route from Node ‘0’ 1002 to Node ‘5’ in cluster 1006 and the route from Node ‘0’ 1002 to Node ‘22’ in cluster 1008). Such crossings can be inefficient and can cause overall costs to rise, which can be an indication that the routes of FIG. 10 may not be optimal.

Having described an overview of some embodiments of the present technology, an example computing environment in which embodiments of the present technology may be implemented is described below in order to provide a general context for various aspects of the present technology.

FIG. 11 is a block diagram illustrating an example computing device 1100 that may implement aspects of the described technology, in accordance with an aspect described herein. FIG. 11 in particular, illustrates an example operating environment for implementing embodiments of the present technology, which is shown and designated generally as computing device 1100. Computing device 1100 is but one example of a suitable computing environment and is not intended to suggest any limitation as to the scope of use or functionality of the technology. Computing device 1100 should not be interpreted as having any dependency or requirement relating to any one or combination of components illustrated.

The technology may be described in the general context of computer code or machine-useable instructions, including computer-executable instructions, such as program modules, being executed by a computer or other machine, such as a cellular telephone, personal data assistant, or other handheld device. Generally, program modules, including routines, programs, objects, components, data structures, etc., refer to code that performs particular tasks or implements particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 11, computing device 1100 includes bus 1102, which directly or indirectly couples the following devices: memory 1104, one or more processors 1106, one or more presentation components 1108, input/output (I/O) ports 1110, input/output components 1112, and illustrative power supply 1114. Bus 1102 represents what may be one or more buses (such as an address bus, data bus, or combination thereof). Although the various blocks of FIG. 11 are shown with lines for the sake of clarity, in reality, delineating various components is not so clear, and metaphorically, the lines would more accurately be grey and fuzzy. For example, one may consider a presentation component, such as a display device, to be an I/O component. A Iso, processors have memory. The inventors recognize that such is the nature of the art, and reiterate that the diagram of FIG. 11 is merely illustrative of an example computing device that can be used in connection with one or more embodiments of the present technology. Distinction is not made between such categories as “workstation,” “server,” “laptop,” “handheld device,” etc., as all are contemplated within the scope of FIG. 11 and with reference to “computing device.”

Computing device 1100 typically includes a variety of computer-readable media. Computer-readable media can be any available media that can be accessed by computing device 1100 and includes both volatile and non-volatile media, and removable and non-removable media. By way of example, and not limitation, computer-readable media may comprise computer storage media and communication media. Computer storage media, also referred to as a communication component, includes both volatile and non-volatile, removable and non-removable media implemented in any method or technology for storage of information, such as computer-readable instructions, data structures, program modules, or other data. Computer storage media includes, but is not limited to, RAM, ROM, EEPROM, flash memory, or other memory technology; CD-ROM, digital versatile disks (DVDs), or other optical disk storage; magnetic cassettes, magnetic tape, magnetic disk storage, or other magnetic storage devices; or any other medium that can be used to store the desired information and that can be accessed by computing device 1100. Computer storage media does not comprise signals per se.

Communication media typically embodies computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, radio frequency (RF), infrared, and other wireless media. Combinations of any of the above should also be included within the scope of computer-readable media.

Memory 1104 includes computer storage media in the form of volatile or non-volatile memory. The memory may be removable, non-removable, or a combination thereof. Example hardware devices include solid-state memory, hard drives, optical-disc drives, etc. Computing device 1100 includes one or more processors that read data from various entities, such as memory 1104 or I/O components 1112. Presentation component(s) 1108 presents data indications to a user or other device. Example presentation components include a display device, speaker, printing component, vibrating component, etc.

I/O ports 1110 allow computing device 1100 to be logically coupled to other devices, including I/O components 1112, some of which may be built-in. Illustrative components include a microphone, joystick, game pad, satellite dish, scanner, printer, wireless device, etc. The I/O components 1112 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition, both on screen and adjacent to the screen, as well as air gestures, head and eye tracking, or touch recognition associated with a display of computing device 1100. Computing device 1100 may be equipped with depth cameras, such as stereoscopic camera systems, infrared camera systems, RGB (red-green-blue) camera systems, touchscreen technology, other like systems, or combinations of these, for gesture detection and recognition. Additionally, the computing device 1100 may be equipped with accelerometers or gyroscopes that enable detection of motion. The output of the accelerometers or gyroscopes may be provided to the display of computing device 1100 to render immersive augmented reality or virtual reality.

At a low level, hardware processors execute instructions selected from a machine language (also referred to as machine code or native) instruction set for a given processor. The processor recognizes the native instructions and performs corresponding low-level functions relating, for example, to logic, control, and memory operations. Low-level software written in machine code can provide more complex functionality to higher levels of software. As used herein, computer-executable instructions includes any software, including low-level software written in machine code; higher-level software, such as application software; and any combination thereof. In this regard, functional components described herein can manage resources and provide the described functionality. Any other variations and combinations thereof are contemplated within embodiments of the present technology.

It is noted and again emphasized that any additional or fewer components, in any arrangement, may be employed to achieve the desired functionality within the scope of the present disclosure. Although the various components of FIGS. 1-10 are shown with lines for the sake of clarity, in reality, delineating various components is not so clear, and metaphorically, the lines may more accurately be grey or fuzzy. Although some components of FIGS. 1-10 are depicted as single components, the depictions are intended as examples in nature and in number and are not to be construed as limiting for all implementations of the present disclosure. The functionality of operating environment 1100 can be further described based on the functionality and features of its components. Other arrangements and elements (for example, machines, interfaces, functions, orders, and groupings of functions, etc.) can be used in addition to or instead of those shown, and some elements may be omitted altogether.

Further, some of the elements described in relation to FIGS. 1-10 are functional entities that may be implemented as discrete or distributed components or in conjunction with other components, and in any suitable combination and location. Various functions described herein are being performed by one or more entities and may be carried out by hardware, firmware, or software. For instance, various functions may be carried out by a processor executing computer-executable instructions stored in memory, such as memory 1104. Moreover, functions of FIGS. 1-10, among other functions, may be performed by a computing device such as 1100, and/or any other component described herein, alone or in any combination.

Referring to the drawings and description in general, having identified various components in the present disclosure, it should be understood that any number of components and arrangements might be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, or software. For instance, various functions may be carried out by a processor executing instructions stored in memory. As such, other arrangements and elements (for example, machines, interfaces, functions, orders, and groupings of functions, etc.) can be used in addition to or instead of those shown.

Embodiments described above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the word “including,” “having,” and other like words and their derivatives have the same broad meaning as the word “comprising,” and the word “accessing” comprises “receiving,” “referencing,” or “retrieving,” or derivatives thereof. Further, the word “communicating” has the same broad meaning as the word “receiving” or “transmitting,” as facilitated by software or hardware-based buses, receivers, or transmitters using communication media described herein.

In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

An optimal solution, as described herein is intended to be the most favorable solution derived from a set of potential solutions generated within the constraints of available processing power and time. This solution minimizes or maximizes the defined objective(s) based on the data and algorithms employed during the computational process. It represents the best solution among those explored, within the computational resources allocated, to solve the optimization problem and achieve the desired logistical outcome. While it may not represent the absolute best solution possible due to limitations in computational resources, data accuracy, or physical interferences, it stands as the most efficient or effective solution identified through the computational process undertaken for a given set of parameters.

For purposes of a detailed discussion above, embodiments of the present technology are described with reference to a distributed computing environment. However, the distributed computing environment depicted herein is merely an example. Components can be configured for performing novel aspects of embodiments, where the term “configured for” or “configured to” can refer to “programmed to” perform particular tasks or implement particular abstract data types using code. Further, while embodiments of the present technology may generally refer to the distributed data object management system and the schematics described herein, it is understood that the techniques described may be extended to other implementation contexts.

From the foregoing, it will be seen that this technology is one well-adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated by the accompanying drawings is to be interpreted as illustrative and not in a limiting sense.

What is claimed is:

1. A computerized method comprising:
receiving a set of problem parameters of an optimization problem, the optimization problem including a solution space greater than a solution space threshold;
performing clustering using the constraint to generate a reduced solution space for the optimization problem, wherein the reduced solution space is smaller than a solution space threshold, the solution space threshold determined based, at least in part, on a solution space threshold for simulated annealing;
performing routing using results of the clustering;
receiving a set of feasible solutions to the optimization problem, the set of feasible solutions generated from simulated annealing using results of the routing, the simulated annealing performed on the reduced solution space;
generating a selected solution to the optimization problem by at least recombining solutions of the set of feasible solutions generated by performing simulated annealing using the reduced solution space; and
providing the selected solution to the optimization problem via a user interface.

2. The computerized method of claim 1, wherein the optimization problem is a vehicle routing problem.

3. The computerized method of claim 1, wherein the optimization problem is a capacitated vehicle routing problem.

4. The computerized method of claim 1, wherein the clustering is performed using a hybrid two-step algorithm.

5. The computerized method of claim 1, wherein the clustering is performed using a hybrid three-step algorithm.

6. The computerized method of claim 1, wherein the simulated annealing step is performed by a quantum routing solver using quantum annealing.

7. The computerized method of claim 1, wherein the clustering comprises:
generating random data points;
calculating a centroid of the random data points;
calculating a distance from each of the random data points to the centroid;
updating membership values of the random data points based, at least in part, on the distance from each of the random data points to the centroid;
defuzzifying the membership values; and
assigning the data points to a cluster based, at least in part, on the defuzzified membership values.

8. The computerized method of claim 1, wherein each solution of the set of solutions is represented as a binary variable vector.

9. The computerized method of claim 1, wherein the optimization problem is formulated in a QUBO (quadratic unconstrained binary optimization) form.

10. The computerized method of claim 1, wherein the simulated annealing step is initialized with an initial solution based, at least in part, on the problem parameters.

11. A computer system comprising:
at least one processor; and
one or more computer storage media storing computer-readable instructions thereon that, when executed by the at least one processor, cause the at least one processor to perform operations comprising:
receiving, at a clustering module, problem parameters of a vehicle routing problem, the vehicle routing problem including a solution space greater than a solution space threshold;
performing, using the clustering module, a clustering algorithm to generate exported clusters, the clustering algorithm based, at least in part, on the problem parameters of the vehicle routing problem, the exported clusters having a reduced solution space that is smaller than the solution space threshold for quantum annealing;
receiving a set of feasible solutions to the vehicle routing problem from a quantum routing solver using quantum annealing on the exported clusters, the quantum annealing performed on the reduced solution space, the quantum annealing initialized with the initial solution based, at least in part, on the problem parameters;
selecting, using an optimal solution selector, a solution to the optimization problem from the set of feasible solutions to the vehicle routing problem, the selecting comprising recombining solutions of the feasible solutions generated by performing quantum annealing on the exported clusters; and
providing, using a user interface, the solution to the optimization problem.

12. The computer system of claim 11, wherein the problem parameters comprise constraints on the vehicle routing problem.

13. The computer system of claim 11, wherein the problem parameters comprise an objective function of the vehicle routing problem.

14. The computer system of claim 11, wherein the clustering algorithm is a fuzzy c-means clustering algorithm.

15. The computer system of claim 11, wherein selecting the solution to the vehicle routing problem further comprises minimizing an objective function of the vehicle routing problem using the quantum annealer.

16. A computer storage medium storing computer-readable instructions that, when executed by one or more computing devices, cause the computing devices to perform operations, the operations comprising:
receiving problem parameters of a vehicle routing problem, the optimization problem including a solution space greater than a solution space threshold;
generating cluster details to generate a reduced solution space for the vehicle routing problem, wherein the reduced solution space is smaller than a solution space threshold, the solution space threshold determined based, at least in part, on a solution space threshold for simulated annealing;
receiving feasible solutions to the vehicle routing problem, the feasible solutions generated from quantum annealing using results of the routing, the simulated annealing performed on the reduced solution space, the quantum annealing initialized with an initial solution based, at least in part, on the problem parameters;
selecting a solution to the optimization problem from the feasible solutions by at least recombining solutions of the feasible solutions; and
providing the solution to the optimization problem via a user interface.

17. The computer storage medium of claim 16, wherein the vehicle routing problem is a capacitated vehicle routing problem.

18. The computer storage medium of claim 16, wherein the problem parameters are received from a vehicle routing problem library instance.

19. The computer storage medium of claim 16, wherein generating the cluster details comprises:
generating soft clusters using a clustering algorithm;
generating final clusters using an assignment algorithm based, at least in part, on the soft clusters; and
generating the cluster details using a cluster exporter based, at least in part, on the final clusters.

20. The computer storage medium of claim 16, further comprising:
receiving an objective function of the optimization problem; and
generating the feasible solutions based, at least in part, on minimizing the objective function.
